(19) United States
(12) Patent Application Publication
(10) Pub. No.: US 2026/0322450 A1
(43) Pub. Date: Oct. 15, 2026

(54) METHODS, ARCHITECTURES, APPARATUSES AND SYSTEMS FOR BEAM-DEPENDENT OPERATION OF SIGNALS AND CHANNELS

(71) Applicant: InterDigital Patent Holdings, Inc., Wilmington, DE (US)

(72) Inventors: Patrick Svedman, Stockholm (SE); Samuli Turtinen, Ii (FI); Paul Marinier, Brossard (CA); Aata El Hamss, Laval (CA); Moon IL Lee, Melville, NY (US); Ghyslain Pelletier, Montréal (CA)

(21) Appl. No.: 19/178,103

(22) Filed: Apr. 14, 2025

(51) Int. Cl. H04B 7/06; H04L 5/00; H04W 72/044

(52) U.S. Cl. CPC H04B 7/0626; H04L 5/0053; H04W 72/046

(57) ABSTRACT

A wireless transmit/receive unit (WTRU) may receive configuration information indicating a set of transmission configuration indicator (TCI) states. The WTRU may receive configuration information indicating a set of signal and/or channel types and a plurality of resource sets which are associated with the set of signal and/or channel types. The WTRU may receive information indicating an association between one or more TCI states, of the set of TCI states, and the plurality of resource sets. The WTRU may receive information indicating a switch from a first TCI state, of the set of TCI states, to a second TCI state, of the set of TCI states. The WTRU may activate one or more of the resources sets that are associated with the second TCI state. The WTRU may send and/or receive a transmission using the activated one or more of the resources sets and the second TCI state.

### BACKGROUND

The present application is related to the fields of communications, software and encoding, including, for example, to methods, architectures, apparatuses, systems directed to the use of appropriate resources corresponding to one or more types of signals and/or channels for an applicable transmission configuration indication (TCI) state (e.g., the applicable beam), such as where TCI states are associated with a resource group.

Wireless systems, such as 5G NR systems, support a variety of implementations. For example, a transmission and/or reception point (TRP) may be implemented with analog, digital, or hybrid beamforming architecture, which may be a combination of analog and digital beamforming.

TRPs with analog or hybrid beamforming may perform reception using a limited set of beams at a time and/or transmission using a limited set of beams at a time. Therefore, the network may need to schedule receptions and/or transmissions using the same limited set of beams simultaneously, such as the receptions from and/or transmissions to different wireless transmit/receive units (WTRUs). Therefore, as different WTRUs move into different beams (e.g., due to TCI state switching), their transmissions and/or receptions may need to be shifted in time. Changes to the time offset of periodic signals and/or channels (e.g., only) with a radio resource control (RRC) reconfiguration is associated with a long delay and overhead. It would be beneficial to provide techniques to efficiently combine TCI state switching with time-alignment of (e.g., periodic) signals and/or channels to and/or from multiple WTRUs that use a same TCI state (e.g., beam).

### BRIEF SUMMARY

Briefly stated, in one embodiment, a WTRU may receive configuration information indicating a set of TCI states. The WTRU may receive configuration information indicating a set of signal and/or channel types and a plurality of resource sets which are associated with the set of signal and/or channel types. The WTRU may receive information indicating an association between one or more TCI states, of the set of TCI states, and the plurality of resource sets. The WTRU may receive information indicating a switch from a first TCI state, of the set of TCI states, to a second TCI state, of the set of TCI states. The WTRU may activate one or more of the resources sets that are associated with the second TCI state. The WTRU may send and/or receive a transmission using the activated one or more of the resources sets and the second TCI state.

In one embodiment, a WTRU may receive configuration information indicating a set of first TCI states. The WTRU may receive configuration information indicating a set of first time and/or frequency resources. The WTRU may receive information indicating an association between the set of first time and/or frequency resources and one or more first TCI states of the set of first TCI states. The WTRU may receive information indicating to send and/or receive a set of transmissions using a set of second time and/or frequency resources in association with one or more second TCI states. The WTRU may determine (i) one or more of the second time and/or frequency resources that at least partially overlap with one or more of the first time and/or frequency resources, and (ii) at least one of the one or more second TCI states associated with the one or more of the second time and/or frequency resources that is included in the one or more first TCI states associated with the one of the first time and/or frequency resources. The WTRU may determine a subset of the set of second time and/or frequency resources based on the determined one or more of the second time and/or frequency resources and the determined at least one of the one or more second TCI states. The WTRU may send and/or receive the set of transmissions using the subset of second time and/or frequency resources.

In one embodiment, a WTRU may receive configuration information indicating a set of TCI states. The WTRU may receive configuration information indicating a set of resource groups. The WTRU may receive configuration information indicating a set of signal and/or channel types and a plurality of resource sets which are associated with the set of signal and/or channel types. The WTRU may receive information indicating an association between the set of resource groups and the plurality of resource sets. The WTRU may receive information indicating an association between one or more TCI states, of the set of TCI states, and one or more resource groups, of the set of resource groups. The WTRU may receive information indicating a switch from a first TCI state, of the set of TCI states, to a second TCI state, of the set of TCI states. The WTRU may activate one or more of the resources sets associated with the resource groups that are associated with the second TCI state. The WTRU may send and/or receive a transmission using the activated one or more of the resources sets and the second TCI state.

In one embodiment, a WTRU may receive an indication to switch from a first TCI state to a second TCI state. The WTRU may deactivate a first set of resources associated with the first TCI state and activate a second set of resources associated with the second TCI state.

In one embodiment, a WTRU may receive an indication of one or more restriction resources associated with one or more restricted TCI states. The WTRU may avoid transmitting and/or receiving on a restriction resource using a restriction TCI state. The WTRU may transmit and/or receive on a restriction resource using a TCI state that is not a restriction TCI state.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is an association diagram illustrating an example of associations between TCI states, resource groups, and resource sets, according to one or more embodiments of the present disclosure;

FIG. 3 is an association diagram illustrating an example of TCI state switching, according to one or more embodiments of the present disclosure;

FIG. 4 is a resource diagram illustrating an example of cancellation of a WTRU transmission, according to one or more embodiments of the present disclosure;

FIG. 5 is a comparative diagram illustrating examples of collision handling of a WTRU transmission, according to one or more embodiments of the present disclosure;

FIG. 6 is a re-ordering diagram illustrating an example of determining a re-ordering of sub-resources, according to one or more embodiments of the present disclosure;

FIG. 7 is a comparative diagram illustrating examples of re-ordering of a WTRU transmission, according to one or more embodiments of the present disclosure;

FIG. 8 is a procedural diagram illustrating an example of a beam-dependent use of transmission and/or reception resources, according to one or more embodiments of the present disclosure; and

FIG. 9 is a procedural diagram illustrating an example of restriction resource-based use of transmission and/or reception resources, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

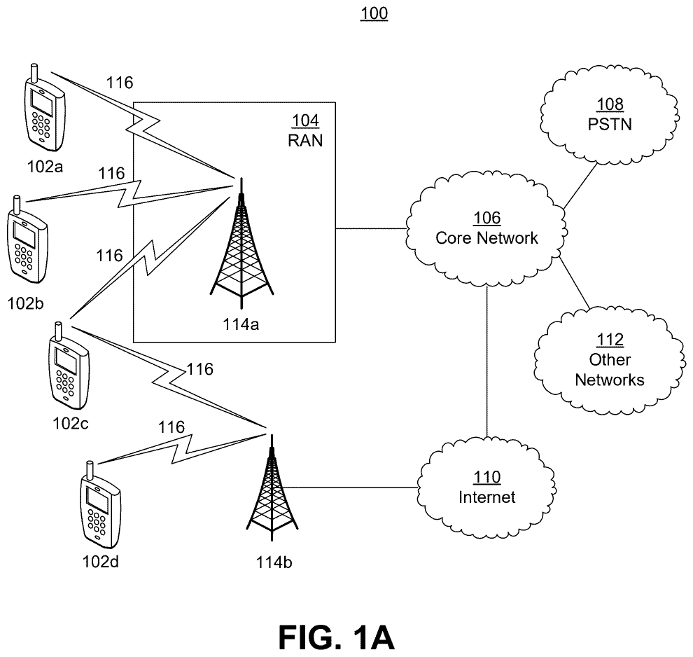

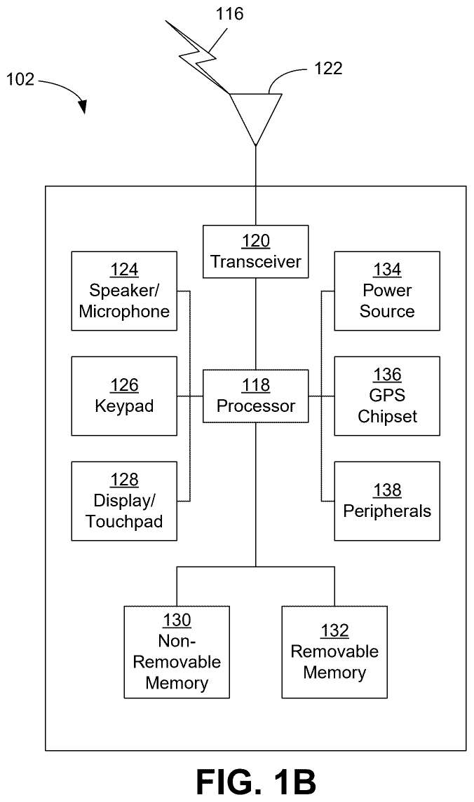

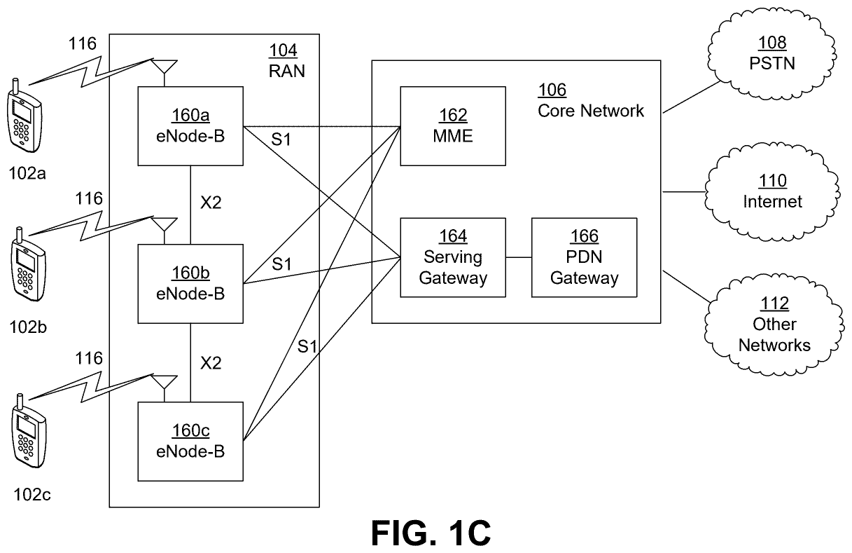

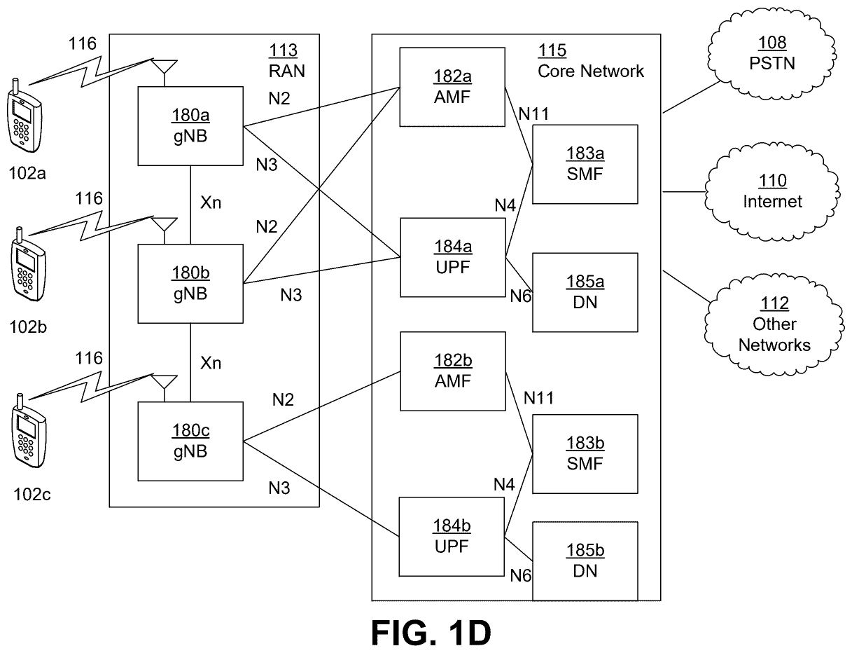

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### Periodic Signals and Channels

Periodic (P) signals and channels are relatively simple for a WTRU 102 to manage, as the WTRU 102 may receive or transmit them periodically upon their configuration, without a need of additional activation or triggering. A periodic signal or channel is typically configured with a periodicity and a time offset relative to a time reference (e.g., a slot offset in relation to a system frame number).

Examples of periodic signals and channels in 5G NR include: downlink (DL) transmissions of synchronization signal/physical broadcast channel block (SSB), channel state information reference signal (CSI-RS), and/or physical downlink control channel (PDCCH) (e.g., in a search space and/or control resource set (CORESET)), and/or uplink transmissions of sounding reference signals (SRS), physical uplink control channel (PUCCH), and/or physical uplink shared channel (e.g., configured grant (CG) type 1). For example, channel transmissions may corresponding demodulation reference signal (DMRS).

In addition to periodicity and slot offset, which may indicate to the WTRU the slot in which the signal and/or channel is to be received or transmitted, other resource information may be configured to the WTRU. Examples of resource information may include any (e.g., combination) of the following: a set of symbols (e.g., within the slot), a set of resource blocks, a set of sub-carriers (e.g., within the resource blocks), a set of orthogonal cover codes (OCC), a set of scrambling sequences, and/or a set of cyclic shifts.

As another example, a periodic signal and/or channel may be configured with quasi-collocation (QCL) information (e.g., one or more TCI states), such as a TCI state that may comprise one or more source RSs and corresponding QCL types.

### Semi-Persistent Signals and Channels

Semi-persistent (SP) signals and channels may be similar to periodic signals and channels in that they may be configured with a periodicity and a time offset. However, upon configuration, a WTRU 102 may receive or transmit a signal or channel only after receiving an additional activation command, which may be carried in a Medium Access Control (MAC) Control Element (CE) or Downlink Control Information (DCI). The signal or channel may also be deactivated using a similar mechanism.

Examples of semi-persistent signals and channels in 5G NR include: DL transmissions of semi-persistent CSI-RS and semi-persistently scheduled (SPS) PDSCH, and UL transmissions of semi-persistent SRS and PUSCH (e.g., configured grant types 1 and 2). The channels may also include corresponding DMRS.

Additional resource information may be configured to the WTRU 102, for periodic signals and/or channels. In some cases, some aspects of the resource allocation may be indicated in the DCI that activates the SP signal and/or channel. For example, a time-frequency resource for SPS PDSCH and PUSCH CG type 2 may be at least partially indicated in the DCI.

### TRPs with Analog and Hybrid Beamforming

Systems, such as 5G NR, support a variety of implementations. For example, a TRP may be implemented with analog, digital, or hybrid beamforming architecture (e.g., a combination of analog and digital beamforming).

In digital beamforming architecture, beamforming is achieved by transmit precoding or receive combining in the digital baseband domain with the highest flexibility. For example, in an OFDM-based system, different precoding/combining can be applied for different sub-carriers in the same symbol.

In analog or hybrid beamforming architecture, on the other hand, the set of beams that can be simultaneously transmitted and/or received may be constrained. For example, in some analog beamforming implementations, only a single beam can be transmitted or received at a time.

In some implementations, multiple beams may be transmitted and/or received at a time. For example, certain combinations of beams may be simultaneously transmitted and/or received. In some implementations such as joint phase time arrays, different beams may be simultaneously transmitted or received, but on different frequencies.

### Unified TCI Framework in 5G NR

The unified TCI framework in 5G NR may be used to indicate QCL relations between different signals and/or channels to a WTRU 102.

The indication mechanism may be a combination of RRC configuration, MAC CE activation/deactivation, and indication by DCI. The network configures, for a bandwidth part (BWP), the WTRU 102 with either a pool of joint DL/UL TCI states (e.g., joint TCI states), or a pool of separate DL TCI states and a pool of separate UL states. A TCI state comprises either one or two source RSs, as well as corresponding QCL types (e.g., type A-D). A source RS may be an RS of a serving cell, or an RS of a non-serving cell (e.g., an SSB with a cell ID corresponding to a non-serving cell).

The WTRU 102 may receive a MAC CE carried in a PDSCH that activates one or more TCI states from the configured pool(s). The activation may also map sets of activated TCI states to TCI codepoints. If the MAC CE activated TCI states for multiple TCI codepoints, the WTRU 102 may be indicated, in a DCI, a TCI codepoint from the multiple codepoints. Some time after the transmission of an acknowledgement corresponding to the DCI, the TCI state(s) mapped to the indicated TCI codepoint become applicable to reception and/or transmission.

The applicable TCI state(s) may be applicable to one or more DL and/or UL signals and/or channels. For example, the TCI state may be applicable to one or more CORESETs, PDSCHs, CSI-RSs, PUCCHs, PUSCHs, and/or SRSs. Different signals and/or channels may be configured to follow the applicable (e.g., unified) TCI state or to follow other mechanisms (e.g., per signal or channel TCI state management).

An applicable TCI state may be configured with a source RS with QCL type D that corresponds to spatial parameter(s).

For example, a WTRU 102 may receive a target DL signal or channel based on the applicable TCI state using a WTRU receive (Rx) beam, or spatial domain receive filter, based on a beam determined based on the reception of the source RS. For instance, the WTRU 102 may determine a suitable Rx beam when receiving the source RS, which may be periodic or transmitted with repetition, and use the determined beam for the reception of the target signal or channel.

For example, a WTRU 102 may transmit a target UL signal or channel based on the applicable TCI state using a WTRU transmit (Tx) beam, or spatial domain transmit filter, based on a WTRU Rx beam determined based on the reception of the source RS (e.g., a Tx beam that corresponds to the Rx beam otherwise referred to as beam correspondence).

### Overview

In certain representative embodiments, in order to have a WTRU 102 use appropriate resources corresponding to one or more types of signals and/or channels for an applied TCI state (e.g., the applied beam), TCI states may be associated, such as by using a resource group. As an example, a resource group may in turn be associated with one or more resource sets, such where a resource set may correspond to a particular signal and/or channel type. Upon TCI state switching, the WTRU 102 may activate resource sets associated with the new applicable TCI state and/or deactivate any other activated resource sets.

For example, periodic transmission with adaptive resource allocation may be achieved by activating and/or deactivating semi-persistent resources upon TCI state switching.

In certain representative embodiments, a WTRU may be configured with a set of TCI states.

In certain representative embodiments, a WTRU may be configured with a set of resource groups.

In certain representative embodiments, a WTRU may be configured with a set of signal and/or channel types. As an example, the signal and channel types may include, among others, PUCCH and SRS. For each of the signal and/or channel types in the set, the WTRU 102 may be configured with a corresponding set of resource sets, where the resources thereof may be semi-persistent.

In certain representative embodiments, a WTRU may receive an indication of an association to a resource group. As an example, in the configuration of a resource set, the resource set may be configured with an association with a resource group (e.g., with a resource group index). As an example, the WTRU may receive a MAC CE that indicates an association with a resource group and one or more resource sets.

In certain representative embodiments, a WTRU may receive one or more indications that associate one or more TCI states with one or more resource groups (e.g., one-to-one association, multiple-to-one association, or one-to-multiple association). As an example, the indications may be configured in the resource group configurations. As an example, the WTRU may receive a MAC CE that indicates the association(s) (e.g., a MAC CE that also activates the TCI states).

In certain representative embodiments, a WTRU may receive an indication to switch from a first TCI state to a second TCI state.

In certain representative embodiments, upon (e.g., after) TCI state switching, a WTRU may WTRU 102 activate the resource set(s) that are associated with the second TCI state, and may deactivate the resource set(s) that are associated with the first TCI state.

In certain representative embodiments, a WTRU may transmit and/or receive one or more transmissions with the activated resource set(s) using the second TCI state.

In certain representative embodiments, a WTRU may receive an indication to switch from a first TCI state to a second TCI state, whereby the WTRU 102 deactivates a first set of resources associated with the first TCI state and activates a second set of resources associated with the second TCI state.

In certain representative embodiments, a WTRU may efficiently adapt the resource allocation of periodic or semi-persistent signals and/or channels upon TCI state switching. This can assist with network implementations since a TRP may keep serving multiple WTRUs in the same resource (e.g., symbol) using the same TRP beam.

### Common Terminology

As used herein, a “signal” and/or a “channel” may be used to refer to a downlink (DL) signal, an uplink (UL) signal, a UL channel, and/or a DL signal. Examples of signals and channels include, but are not limited to, transmission and/or reception of any of the following: channel state information reference signal (CSI-RS), physical downlink control channel (PDCCH), physical downlink shared channel (PDSCH), DL demodulation reference signal (DMRS) (e.g., PDCCH DMRS or PDSCH DMRS), positioning reference signal (PRS), synchronization signal block (SSB) (e.g., cell-defining SSB, non-cell-defining SSB, on-demand SSB, always-on SSB, etc.), sounding reference signal (SRS), physical uplink control channel (PUCCH), physical uplink shared channel (PUSCH), UL DMRS (e.g., PUCCH DMRS or PUSCH DMRS), and/or physical random access channel (PRACH).

In certain representative embodiments, a signal and/or channel may correspond to one or more resources. Examples may include CSI-RS resource(s), resource(s) for a PDCCH resource/occasion (e.g., a CORESET and/or search space), PDSCH resource(s), SRS resource(s), PUCCH resource(s), PUSCH resource(s), PRACH resource(s), and the like. As used herein, the terms signal and channel may correspond to the signal or channel itself, or a signal and/or channel resource, such as those described above.

As used herein, a “resource” may be used to refer to any of time resource(s), frequency resource(s), spatial resource(s) (e.g., beam-related or TCI-related resource(s)), code resource(s), scrambling sequence resource(s), cyclic shift resource(s), etc. For example, a resource may comprise any (e.g., combination) of the following: a set of time resources (e.g., a set of one or more consecutive or non-consecutive time symbols, such as OFDM symbols), a set of frequency resources (e.g., one or more range(s) of frequencies, a set of one or more sub-carriers and/or one or more resource blocks, a set of spatial resources (e.g., set of beams, e.g., corresponding to TCI state(s)), a set code resources (e.g., one or more orthogonal cover code(s)), a set of scrambling sequences (e.g., one or more scrambling sequence IDs), and/or a set of cyclic shifts.

In certain representative embodiments, a resource may be associated with one or more periodicities and/or one or more time offset(s), which may be configured to the WTRU 102 (e.g., one or more candidate periodicities and/or one or more candidate time offsets). For example, a resource may be repeated with a periodicity from one or more (e.g., candidate) periodicities. The set of time resources of a resource may occur at a time offset from one or more (e.g., candidate) time offset(s) from a reference timing (e.g., a system frame boundary, a sub-frame boundary). The periodicity and/or time offset may be configured in multiples of symbols, slots, sub-frames, or other units of time.

In certain representative embodiments, a set of time resources may comprise time-domain repetition, wherein a subset of time resources is repeated multiple times in the time domain. A resource may repeat in time in addition to the repetition offered by periodic transmission (e.g., a repetition pattern may repeat in time with the periodicity). The repetitions may be consecutive or non-consecutive in time. The time difference (e.g., offset) between subsequent time repetitions may be an integer number of symbols, slots, etc. The set of time resources may comprise one or more candidate time resources.

In certain representative embodiments, a set of frequency resources may comprise frequency-domain repetition, wherein a subset of frequency resources is repeated multiple times in the frequency domain. The repetitions may be consecutive or non-consecutive in frequency. The frequency difference (e.g., offset) between subsequent frequency repetitions may be an integer number of sub-carriers, RBs, or other units in the frequency domain. The set of frequency resources may comprise one or more candidate frequency resources.

In certain representative embodiments, a set of frequency resources may comprise resources with frequency hopping, such that different subsets of frequency resources correspond to different subsets of time resources. In an example, frequency hopping may correspond to time repetition and frequency repetition.

In certain representative embodiments, a resource may comprise multiple sub-resources. For instance, a resource with frequency hopping may comprise multiple sub-resources, wherein a sub-resource may correspond to a hop (e.g., a combination of (subsets of) time-, frequency-, etc., resources corresponding to a hop).

In certain representative embodiments, a resource comprising repetition (e.g., in time and/or frequency) may comprise multiple sub-resources, wherein a sub-resource may correspond to a repetition occasion. A resource may comprise multiple candidate sub-resources.

In certain representative embodiments, a frequency hop, a time repetition occasion, a frequency repetition occasion, etc., may correspond to a resource, and the set of hops or repetition occasions may correspond to a set of resources.

In certain representative embodiments, a resource may correspond to a signal and/or channel resource as in the examples above.

As used herein, a “TCI state” may refer to a unified TCI state (e.g., as in state-of-the-art systems and/or as described herein). A TCI state may refer to an enhanced unified TCI state (e.g., based on the 5G unified TCI state and/or as specified for 6G radio).

For example, a TCI state may also more generally refer to a WTRU method of receiving a signal and/or channel and/or a WTRU method of transmitting a signal and/or channel. In other words, different TCI states may represent different ways of receiving and/or transmitting a signal or channel. A TCI state may be applicable to one or more signals and/or channels, which may be called target signals and/or channels. The WTRU 102 may determine a method of receiving and/or transmitting the target signal and/or channel based on a source signal and/or channel (e.g., a source RS in an applicable TCI state).

In certain representative embodiments, a TCI state may correspond to one or more pieces of QCL information. A piece of QCL information may correspond to a QCL relation between a source signal and/or channel and a target signal and/or channel (e.g., the target channel to which the TCI state is applicable). A QCL relation between a source signal and/or channel and target signal and/or channel may correspond to where one or more (e.g., QCL) parameters may be applicable to both the source and the target. As an example, the WTRU 102 may determine one or more parameters from a source signal or channel and use the determined parameter(s) for receiving or transmitting a corresponding target signal or channel, such as where the parameter(s) may correspond to parameter(s) in a method of receiving or transmitting the signal or channel. TCI state switching for a target signal and/or channel may therefore involve switching of applicable source RS(s).

In certain representative embodiments, example QCL parameters may include those in state-of-the-art systems (e.g., QCL types A, B, C, D) representing combinations of average delay, delay spread, Doppler shift, Doppler spread, spatial Rx parameter. QCL parameters may also involve a spatial Tx parameter or spatial domain filter. For example, a WTRU 102 may determine a spatial domain transmission filter for a target signal and/or channel based on a spatial domain receive filter for a first source signal and/or channel. A spatial domain receive filter for a first source signal and/or channel may be determined by receiving the first source signal and/or channel and determining the filter based on the received signal and/or channel. A spatial domain receive filter for a first source signal and/or channel may be determined based on a second source signal and/or channel, wherein the first source signal and/or channel may be a target signal and/or channel of the second source signal and/or channel. In other words, a WTRU 102 may be configured and/or indicated with multiple QCL relations that comprise a QCL chain, wherein one or more signals and/or channels may serve as both target and source.

As used herein, a “spatial parameter” or “spatial domain filter” may be used to refer to a WTRU 102 beam (e.g., Rx beam and/or Tx beam). A TCI state may correspond to a WTRU 102 beam (e.g., a Rx beam and/or a Tx beam). The WTRU 102 Rx beam and WTRU 102 Tx beam may correspond to the same or similar spatial or directional electro-magnetic transmission and/or reception properties (e.g., when the WTRU 102 supports and applies Rx/Tx beam correspondence).

In certain representative embodiments, a TCI state may be associated with one or more parameters of a reception and/or transmission method that are not necessarily QCL parameters. Examples may include power control parameters, codebook parameters, transmission scheme parameters (e.g., codebook-based or non-codebook-based), antenna parameters, such as antenna ports, etc.

For example, switching from a first TCI state to a second TCI state for a target signal and/or channel may involve switching the reception and/or transmission method and/or parameter(s) related to the reception and/or transmission of the target signal and/or channel.

For example, upon switching to a TCI state, the TCI state may be applicable to reception and/or transmission (e.g., of signals and/or channels configured to be affected by the TCI state switching, such as target signal(s) or channel(s)). For example, a set of signals and/or channels may be configured to follow a unified TCI state (e.g., a TCI state as described herein). Upon (e.g., unified) TCI state switching to a TCI state, the TCI state may be applicable to the signals and/or channels in the set of signals and/or channels.

As used herein, a “bandwidth part” may refer to a BWP as used in 5G NR, where it may correspond to a configurable entity that is associated with a range of frequencies, a sub-carrier spacing, and various other configurable parameters. Herein, the term BWP may also be used more broadly (e.g., to correspond to one or more parts of a bandwidth). A BWP may correspond to a contiguous range of frequencies (e.g., a set of contiguous sub-carriers). A BWP may correspond to a non-contiguous range of frequencies (e.g., a set of non-contiguous sub-carriers), which may correspond to a plurality of sets of contiguous sub-carriers that are non-overlapping and separated in frequency. A BWP may also correspond to a plurality of non-contiguous ranges of frequencies. A BWP may correspond to one or more carriers. A carrier may correspond to one or more BWPs. A BWP may correspond to one or more cells (e.g., serving cells). A cell (e.g., serving cell) may correspond to one or more BWPs.

As used herein, an “ID” may be used to refer to any of an identity, identities, index, indices, identifier(s), and/or similar descriptors.

As used herein, a “configuration” and “configuration information” may correspond to one or more indications of one or more parameters, or similar, that a WTRU 102 may receive. The one or more parameters may configure one or more WTRU 102 functions, WTRU 102 methods, WTRU 102 procedures, etc. For example, a WTRU 102 being configured with a parameter may correspond to the WTRU 102 receiving a configuration comprising an indication of a value of the parameter.

In certain representative embodiments, a configuration may correspond to an initial configuration and/or to a reconfiguration. A reconfiguration may change, add, remove, etc., parameters in a previously received configuration.

In certain representative embodiments, a configuration or part thereof may be received with radio resource control (RRC) signaling (e.g., in one or more RRC message(s), such as via RRCSetup, RRCResume, RRCReconfiguration, RRCReestablishment, and/or any other RRC message(s)).

In certain representative embodiments, a configuration or part thereof may be received with medium access control (MAC) signaling (e.g., in one or more MAC message(s)). For example, MAC signaling may apply ASN.1 encoding and/or may be comprised of MAC control messages, or may be used in the form of MAC CEs (Control Elements). A MAC signaling message or MAC control message may be distinct from MAC CEs.

In certain representative embodiments, a configuration or part thereof may be received in one or more messages. A message carrying a configuration may comprise RRC signaling and/or MAC signaling.

In certain representative embodiments, a WTRU 102 may receive a configuration from a network. In some cases, a first part of a WTRU 102's configuration parameters may be received with RRC signaling and a second part of the WTRU 102's configuration parameters may be received with MAC signaling. For example, the first part may comprise parameters related to functionality common to one or more distributed units (DUs) associated with a central unit (CU), wherein DU and CU may be network entities. Hence, the CU may indicate to the WTRU 102 the first part to the WTRU 102 (e.g., using RRC signaling). The second part may comprise parameters related to functionality that may be controlled by the DU. Hence, the WTRU 102 may receive the second part from one or more DU(s) (e.g., using MAC signaling). In another example, a WTRU 102 may receive configuration information from both the CU and DU with RRC signaling. In yet another example, a WTRU 102 may receive configuration information from both the CU and DU with MAC signaling.

### Configuration of TCI States

In certain representative embodiments, the network (e.g., base station, TRP) may transmit and/or a WTRU 102 may receive one or more configurations and/or reconfigurations (e.g., with RRC signaling, in one or more RRC message(s), and/or with MAC signaling). For example, a configuration may be applicable to the WTRU 102, to one or more serving cell(s) of a WTRU 102, and/or to one or more BWPs of a WTRU 102, (e.g., where a BWP may be associated with one or more serving cells).

In certain representative embodiments, a WTRU 102 may be configured with one or more TCI states, such as one or more pools (e.g., sets) of TCI states (e.g., as in the unified TCI framework described herein).

In certain representative embodiments, a TCI state may be configured to be applicable to any of DL signals and/or channels, UL signals and/or channels, and/or both. In some embodiments, a WTRU 102 may determine that a TCI state is applicable to DL transmissions, UL transmissions, or both, such as based on a TCI state activation (e.g., carried in a MAC CE).

In certain representative embodiments, a TCI state may be applicable to one or more BWP(s), one or more carrier(s), one or more serving cell(s), and/or one or more frequency band(s), etc., such as by configuration. The WTRU 102 may receive a list of BWP(s), carrier(s), serving cell(s), and/or band(s), which may indicate the applicability of the configured one or more TCI states.

In certain representative embodiments, a WTRU 102 may be configured with one or more TCI state sets, where a given TCI state set may comprise one or more TCI states. A TCI state set may be associated with (e.g., configured with) a TCI state set ID.

In certain representative embodiments, a signal, channel, and/or corresponding resource may be configured (e.g., to be associated) with one or more TCI states. A signal, channel and/or corresponding resource may be configured (e.g., to be associated) with one or more TCI state sets.

### Configuration of Resource Groups

In certain representative embodiments, a WTRU 102 may receive a configuration of a set of one or more resource groups.

In certain representative embodiments, one or more resource groups may be applicable to one or more BWPs. For example, a resource group may be applicable to the same set of BWPs that the configured one or more TCI states may be applicable to.

In certain representative embodiments, one or more resource groups may be applicable to one or more carriers. For example, a resource group may be applicable to the same set of carriers that the configured one or more TCI states may be applicable to.

In certain representative embodiments, one or more resource groups may be applicable to one or more serving cells. For example, a resource group may be applicable to the same set of serving cells that the configured one or more TCI states may be applicable to.

In certain representative embodiments, one or more resource groups may be applicable to one or more frequency bands. For example, a resource group may be applicable to the same set of frequency bands that the configured one or more TCI states may be applicable to.

In certain representative embodiments, a WTRU 102 may receive a configuration that indicates the BWP(s), carrier(s), serving cell(s), and/or band(s) that one or more resource groups may be applicable to.

In certain representative embodiments, a resource group may be associated with (e.g., configured with) a resource group ID. The ID may be defined (e.g., unique) within the BWP(s), carrier(s), serving cell(s), and/or frequency band(s), to which the resource group(s) is or are applicable.

In some embodiments, a resource group ID may comprise a combination of an ID corresponding to a resource group and an ID of one or more BWP(s), carrier(s), serving cell(s), and/or frequency band(s), such that a resource group can be (e.g., uniquely) identified within multiple BWPs, carriers, serving cells, and/or frequency bands.

In certain representative embodiments, a resource group configuration may be provided through RRC signaling (e.g., over RRCSetup, RRCResume, RRCReconfiguration, RRCReestablishment, or any other RRC message). In certain representative embodiments, MAC signaling may be used to (e.g., additionally or alternatively) configure or reconfigure the resource groups. For example, MAC signaling may apply ASN.1 encoding and/or may be comprised of MAC control messages, or may be used in the form of MAC CEs.

### Configuration of Resources

### General

In certain representative embodiments, a WTRU 102 may receive a configuration of one or more resources, such as in one or more BWPs, carriers, serving cells, frequency bands, or the like.

In certain representative embodiments, a configuration of a resource may comprise a set of one or more resource parameters. For example, a WTRU 102 may be configured with different resources with different sets of one or more resource parameters. The resources may be associated with (e.g., configured with) resource IDs. Different resources may be associated with the same or different IDs. A resource may be associated with (e.g., configured with) one or more sub-resources and/or parameters (e.g., frequency hops, repetitions, etc.).

In certain representative embodiments, one or more resource parameters may correspond to a resource allocation in one or more dimensions, such as time, frequency, code, space, cyclic shift, scrambling, etc. One or more resource parameter(s) may correspond to candidate resource parameter(s), which may correspond to candidate resource (or sub-resource) allocation(s) in one or more dimensions (e.g., time, frequency, code, space, cyclic shift, scrambling, and/or the like).

In certain representative embodiments, a resource may be configured to be periodic, semi-persistent, or aperiodic.

In certain representative embodiments, a resource configuration may be provided through RRC signaling (e.g., over RRCSetup, RRCResume, RRCReconfiguration, RRCReestablishment, or any other RRC message). In certain representative embodiments, MAC signaling may be (e.g., alternatively or additionally) used to configure or reconfigure the resources. For example, MAC signaling may apply ASN.1 encoding and/or may be comprised of MAC control messages, or may be used in the form of MAC CEs.

### Resource Types

In certain representative embodiments, a resource may be associated with (e.g., configured with) a resource type, such as according to the type(s) of signals and/or channels carried on the resource. For example, a resource type may be associated with a single type of signal and/or channel or with multiple types of signals and/or channels. Without loss of generality, the example where a resource is associated with a single type of signal and/or channel is primarily used herein. However, it should be understood that a (e.g., same) resource may be associated with multiple types of signals and/or channels.

In certain representative embodiments, different resources (e.g., of different types) may be associated with (e.g., configured with) the same ID. The resources may still be distinguishable in signaling (e.g., by the different types).

In some embodiments, a resource type may be a time-frequency resource type. For example, a time-frequency resource type may not be associated with a particular signal and/or channel type. A resource of a time-frequency resource type (e.g., a time-frequency resource) may comprise or otherwise correspond to a set of time resources and a set of frequency resources.

In some embodiments, a resource type may be a time resource type. For example, a time resource type may not be associated with a particular signal and/or channel type. A resource of a time resource type (e.g., a time resource) may comprise or otherwise correspond to a set of time resources.

In some embodiments, a resource type may be a frequency resource type. For example, a frequency resource type may not be associated with a particular signal and/or channel type. A resource of a frequency resource type (e.g., a frequency resource) may comprise or otherwise correspond to a set of frequency resources.

### Resource Sets

In certain representative embodiments, a WTRU 102 may receive an indication (e.g., in a configuration) that divides the resources (e.g., of a particular type) into a set of one or more resource sets, such as where a resource set comprises one or more resources of a particular type. A resource set may be associated with (e.g., configured with) a resource set ID.

In certain representative embodiments, a resource may (e.g., alternatively) correspond to multiple candidate resource (or sub-resource) allocations, and a WTRU 102 may receive an indication (e.g., in a configuration) that assigns candidate (sub-)resource allocations to a set of one or more resource sets. A resource set may comprise a subset (e.g., one or more) of the multiple candidate (sub-)resource allocations of a resource. A resource set may comprise subsets of candidate (sub-)resource allocations of multiple resources. In an example, the different resource sets (e.g., of a type) may each comprise a candidate (sub-)resource allocation (e.g., of a resource of the type).

In certain representative embodiments, a resource set may comprise resources from any of one or more BWPs, carriers, serving cells, frequency bands, etc.

For example, a resource set may correspond to one or more resources, and a resource set ID may correspond to a resource ID.

In certain representative embodiments, a WTRU 102 may be configured with multiple kinds and/or types of resource sets. A resource set that comprises one or more resources may enhance the signaling efficiency for various WTRU 102 functions, such as where a resource set and corresponding ID may be used to address a set of resources. Different kinds of resource sets may be used for different functions, such as where they are configured separately. However, a (e.g., kind of) resource set may also be used for multiple functions, such as where the same resource set configuration may be used for multiple functions.

For example, the resource sets considered herein may be of a different kind than some other resource sets (e.g., separately configured). For example, the resource sets considered herein may also be used for other functions.

In certain representative embodiments, the scope (e.g., per WTRU 102, per band, per serving cell, per BWP, etc.) of a resource set may be different for different kinds of resource sets. In an example, a resource set of a first kind or type may comprise one or more resource sets of a second kind or type. For example, a resource set of a second kind or type may comprise one or more resources in a BWP and/or in a serving cell. Hence, in an example, a resource set of the first kind may comprise the resources in multiple BWPs and/or serving cells that correspond to the multiple resource sets of the second kind.

### CSI Reporting

In certain representative embodiments, a WTRU 102 may receive a configuration that indicates one or more CSI reporting configurations and/or CSI reporting settings.

In certain representative embodiments, a CSI reporting configuration may indicate a resource for channel measurement (e.g., a DL RS such as CSI-RS). In certain representative embodiments, a CSI reporting configuration may indicate a resource set for channel measurement (e.g., a resource set of the first kind or a resource set of second kind). In certain representative embodiments, a CSI reporting configuration may indicate a set of resource sets for channel measurement.

In certain representative embodiments, CSI reporting may correspond to periodic, semi-persistent, or aperiodic reporting. For example, a CSI reporting configuration may indicate a CSI reporting resource (e.g., a PUCCH resource or a PUSCH resource). For example, a CSI reporting configuration may indicate a set of one or more CSI reporting resources (e.g., a set of one or more PUCCH resources and/or a set of one or more PUSCH resources). For example, a CSI reporting resource and/or set thereof may be periodic, semi-persistent, or aperiodic.

In certain representative embodiments, PUCCH resources in a set of CSI reporting resources may be configured to be included in the same or different resource sets (e.g., of the PUCCH type). For example, a resource set (e.g., of the PUCCH type) may be configured to include none, one, or multiple CSI reporting resources (e.g., PUCCH resources).

In certain representative embodiments, PUSCH resources in a set of CSI reporting resources may be configured to be included in the same or different resource sets (e.g., of the PUSCH type).

In a simple non-limiting example, a WTRU 102 may be configured with a set of 16 resource sets of the PUCCH type, where each resource set comprises 8 PUCCH resources. In other words, the set of resource sets comprises 16 times 8, or 128, PUCCH resources. For example, the WTRU 102 may receive a CSI reporting configuration that indicates a set of 16 CSI reporting resources (e.g., comprising a PUCCH resource in each of the 16 resource sets).

### Indication of Association Between Resources and Resource Groups

### General

In certain representative embodiments, the network may transmit and a WTRU 102 may receive one or more indications (e.g., configuration(s) and/or reconfiguration(s)) to associate one or more of the configured resource sets with one or more configured resource groups.

In certain representative embodiments, a resource group may be associated with resource sets corresponding to DL signals and/or channels (e.g., one or more of the types CSI-RS, PDCCH, PDSCH, etc.).

In certain representative embodiments, a resource group may be associated with resource sets corresponding to UL signals and/or channels (e.g., one or more of the types SRS, PUCCH, PUSCH, PRACH, etc.).

In certain representative embodiments, a resource group may be associated with resource sets corresponding to both DL and UL signals and/or channel.

For example, a configuration may associate one resource set to one resource group.

For example, a configuration may associate one resource set to multiple resource groups.

For example, a configuration may associate multiple resource sets to one resource group.

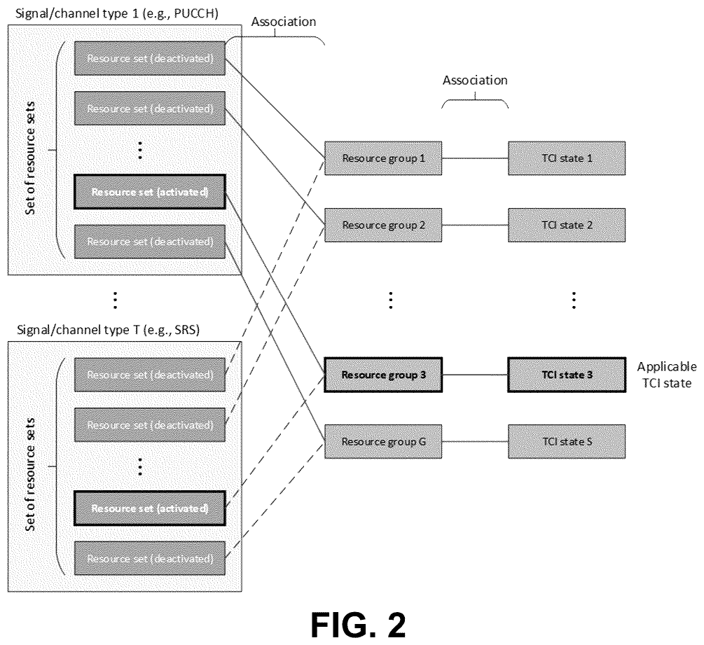

FIG. 2 is an association diagram illustrating an example of associations between TCI states, resource groups, and resource sets, according to one or more embodiments of the disclosure. As shown in FIG. 2, a set of resource sets may be associated per signal and/or channel type (e.g., PUCCH and SRS). In some embodiments, there may be multiple sets of resource sets associated with a particular signal and/or channel type. Various approaches described herein may be applicable to each of the sets of resource sets associated with a same type.

In FIG. 2, a WTRU 102 may be configured with T sets of resource sets for T types of signals and/or channels. Each set of resource sets may include multiple resource sets. For example, in the set of resource sets associated with the T^{th} signal and/or channel type, a resource set may be activated while the other resource sets may be deactivated. The WTRU 102 may be configured with G resource groups. For example, each of the resource groups may be associated with multiple resource sets. For example, a resource group may be associated with a resource set for each of the signal and/or channel types. The WTRU 102 may be configured with S TCI states. For example, each of the TCI states may be associated with at least one of the G resource groups.

In certain representative embodiments, different resources groups may be associated with different BWPs. For example, a resource group may be configured with an indicator of a BWP (e.g., a BWP ID). For example, this may imply that the resources or resource sets associated with the group are associated with the BWP (e.g., they are within the BWP and/or they are configured in the corresponding configuration). An indication of a resource or resource set to be associated with a resource group may be interpreted based on the BWP being associated with the resource group. For instance, an indicated resource ID or resource set ID may refer to an ID associated with a BWP (e.g., configured for the BWP). In another example, the resources or resource sets associated with a resource group may be associated with one or more BWPs. In another example, a BWP may be associated directly with a TCI state (e.g., by the indication and/or configuration of a BWP ID with the activation and/or configuration of a TCI state).

In certain representative embodiments, TCI state switching may imply BWP switching (e.g., activation of a BWP that is associated with a resource group associated with the TCI state that is switched to, or a BWP associated with the TCI state that is switched to). In certain representative embodiments, a BWP associated with a TCI state that is switched from (e.g., directly or via an associated resource group) may be deactivated.

In certain representative embodiments, a WTRU 102 may receive an indication to change the association between resource groups and resource sets (e.g., based on reconfiguration). For example, reassociation may follow the same principles as the initial association (e.g., always done by RRC signaling/configuration), or may be done differently (e.g., initial association may be provided via configuration, such as RRC configuration, and re-association may be provided via MAC signaling, such by a MAC CE).

In certain representative embodiments, the network may provide and/or a WTRU 102 may receive an indication of (e.g., all) the associated resource set IDs for a specific resource group in an association (re-)configuration (e.g., through RRC, MAC signaling, and/or via MAC CE). In some embodiments, any previously associated resource set ID for a specific resource group may be considered to not be associated for the specific resource group after receiving a reconfiguration (e.g., at the WTRU 102). For example, the WTRU 102 may receive an indication in the reconfiguration whether any previously associated resource set IDs are still valid for the specific resource group or not.

In certain representative embodiments, a WTRU 102 may transmit an indication of a capability of a number of resource sets and/or resource groups that the WTRU 102 may be able to support (e.g., concurrently).

In certain representative embodiments, a TCI state may be associated with one or more resource sets without using resource groups as an intermediary. For example, a WTRU 102 may receive information directly indicating the associations between a TCI state and one or more resource sets, such as via resource set IDs for a TCI state (e.g., in a TCI state configuration). For example, the association may be indicated by indicating one or more TCI states for a resource or resource set (e.g., in a resource set configuration).

### Indication by Configuration

In certain representative embodiments, a configuration and/or reconfiguration of one or more resource groups and one or more resource sets may be received by the WTRU 102 (e.g., through RRC and/or MAC signaling). As an example, the association (e.g., at least initial association) between a resource group and a resource set may be provided within a configuration or reconfiguration.

In certain representative embodiments, an association between one or more resource sets and a resource group may be performed based on an indication of one or more resource set IDs of the corresponding resource sets in the resource group configuration, or vice versa.

In certain representative embodiments, an association between a resource set and a resource group may be performed based on indications of both the resource set ID and the resource group ID in a TCI state configuration.

In certain representative embodiments, an (e.g., separate) association configuration may provided where a resource set ID is associated with one or more resource group IDs, or vice versa. In one example, a separate association configuration may provide a list of resource set IDs and associates it with a list of resource group IDs, such as where each list can consist of one or more entries or IDs.

In certain representative embodiments, an association (re-)configuration may be provided in a RRCSetup, RRCResume, RRCReconfiguration, RRCReestablishment, and/or any other RRC message.

In certain representative embodiments, upon (re-)configuration of an association by RRC signaling, a WTRU 102 may be able to apply the new association between a resource set and a resource group at the latest upon transmission of a RRCSetup, RRCResume, RRCReconfiguration, or RRCReestablishment complete message. In some embodiments, the association (re-)configuration may be received by the WTRU 102 in MAC signaling messaging, such as which may be distinct from MAC CEs.

### Indication by MAC CE

In certain representative embodiments, a configuration and/or reconfiguration of the one or more resource groups and one or more resource sets may be received by the WTRU 102 (e.g., through RRC and/or MAC signaling). The association or re-association between the resource groups and the resource sets may be done further via MAC CE(s). For example, an initial association may be provided through the RRC and/or MAC signaling upon configuration of the resources, resource sets, and resource groups while the re-association may be provided by one or more MAC CE. In another example, the associations may (e.g., only) be provided by one or more MAC CEs.

In certain representative embodiments, a MAC CE may be defined and/or specified for associating resource groups and resource sets. In one example, a MAC CE may indicate the association of a resource group and one or more resource sets. In one example, a MAC CE may indicate the association of a resource set and one or more resource groups. In one example, a MAC CE may indicate the association of one or more resource groups and one or more resource sets.

In certain representative embodiments, a MAC CE may indicate a resource group ID and each resource set ID that is associated with the resource group ID. For example, a MAC CE may indicate a resource group ID and a associated set of resource set IDs. As an example, The MAC CE may comprise a sequence of a first group ID, a first set of resource set IDs associated with the first group ID, a second group ID, a second set of resource set IDs associated with the second group ID, and so forth. For example, a resource group ID and/or a resource set ID may be followed (e.g., in the MAC CE) by an indication that another resource group ID and/or a resource set ID follows the resource group ID and/or resource set ID in the MAC CE. The receiving MAC entity (e.g., at the WTRU 102) may deduce when no more resource group ID and resource set ID associations follow based on the length of the MAC CE.

In certain representative embodiments, a MAC CE may (e.g., alternatively) indicate a resource group ID and a field indicating the number of resource set IDs that will follow and are associated with this resource group ID. Furthermore, another field may indicate whether another resource group ID (e.g., and associated resource sets) will follow this set of resource group ID and resource IDs in this MAC CE, or alternatively the receiving MAC entity (e.g., at the WTRU 102) may determine if another resource group ID (e.g., and associated resource sets) will follow based on the length of the MAC CE.

In certain representative embodiments, a MAC CE that activates a set of TCI states may (e.g., also) indicate the association between a resource group ID and resource set ID (e.g., and which are then associated with a corresponding TCI state in the set of TCI states).

In certain representative embodiments, a MAC CE may (e.g., only) reconfigure the association through resource set and resource group IDs (e.g., to not expose the actual resources associated with the configuration, such as in case the MAC CE is not protected).

### Indication of Restriction Resources

### Restriction Resource

As used herein, the terms “restriction” and “blanking” may be used interchangeably. As used herein, the terms “restricted” and “blanked” may be used interchangeably.

In certain representative embodiments, a WTRU 102 may receive an indication of one or more restriction resources.

In certain representative embodiments, a restriction resource may be a resource, such as a time-frequency resource (e.g., a set of time resources and a set of frequency resources), a time resource (e.g., a set of time resources), or a frequency resource (e.g., a set of frequency resources).

In certain representative embodiments, a restriction resource may be a resource that corresponds to a signal and/or channel (e.g., a periodic or semi-persistent channel).

### Indication by Configuration

In certain representative embodiments, a WTRU 102 may receive an indication of one or more restriction resources in a configuration of one or more (e.g., restriction) resources.

In certain representative embodiments, a WTRU 102 may receive a configuration comprising a list of restriction resources. For example, a restriction resource may be configured with a restriction resource ID.

In certain representative embodiments, a WTRU 102 may be configured with one or more sets of restriction resource sets. The WTRU 102 may receive a configuration comprising a list of restriction resource sets. The configuration of a restriction resource set may comprise a list of restriction resources. For example, a restriction resource set may be configured with a restriction resource set ID.

In certain representative embodiments, a restriction resource set may comprise restriction resources from any of one or more BWPs, carriers, serving cells, frequency bands, etc. For example, a restriction resource may be (e.g., uniquely) identified by a restriction resource ID and one or more of a BWP ID, a carrier ID, a serving cell ID, and/or a frequency band ID. In another example, a restriction resource ID may be (e.g., uniquely) configured across multiple BWPs, carriers, serving cells, and/or frequency bands.

In certain representative embodiments, a resource and/or resource set corresponding to a signal and/or channel may be configured to be a restriction resource and/or resource set, such as by the inclusion of an additional and/or optional parameter. In another example, a resource and/or resource set may be configured with a (e.g., priority) parameter with one or more values corresponding to the resource and/or resource set being a restriction resource and other values corresponding to the resource and/or resource set not being a restriction resource.

### Indication by MAC CE

In certain representative embodiments, a WTRU 102 may receive an indication of one or more restriction resources and/or one or more restriction resource sets carried via MAC (e.g., a MAC CE). The indication may indicate that the indicated restriction resources are activated and/or deactivated. In an example, a restriction resource may be either in an activated and/or a deactivated state. An activated restriction resource may correspond to restriction being applicable or applied. A deactivated restriction resource may correspond to restriction not being applicable or applied. For example, the MAC CE activation may be handled as an activation of the corresponding restriction.

In certain representative embodiments, a MAC CE that indicates activation of one or more restriction resources may (e.g., implicitly) indicate deactivation of other restriction resources, such as previously activated restriction resources that were not among the indicated restriction resources in the activation MAC CE.

In certain representative embodiments, a restriction resource and/or restriction resource set activation or deactivation may take effect a time offset after the WTRU transmission that carries an (e.g., HARQ) acknowledgement of the successful reception of the MAC CE, or the PDSCH that carried the MAC CE.

In certain representative embodiments, a restriction resource and/or restriction resource set activation may be applicable for a time duration. For example, the WTRU 102 may receive a configuration of a time duration (e.g., a timer value) of how long the activated restriction resource is activated. For example, upon expiry of the time duration or after the time duration has elapsed, the WTRU 102 may deactivate the restriction resource. The time duration may be configured separately or provided dynamically in the activation or deactivation MAC CE. A (e.g., same) time duration may be applied for all the restriction resources or on a per restriction resource basis.

In certain representative embodiments, the activation/deactivation of a restriction resource corresponding to a semi-persistent signal and/or channel may be received in a MAC CE that may activate/deactivate the semi-persistent signal and/or channel resource and/or resource set. The activation/deactivation of the restriction resource may correspond to, or follow, the activation/deactivation of the semi-persistent signal and/or channel resource and/or resource set.

In certain representative embodiments, a MAC CE may include an indication of whether the activation of a signal and/or channel resource and/or resource set also implies the activation of the corresponding restriction resource. Hence, a semi-persistent signal and/or channel resource (or resource set) may be activated with or without restriction.

In certain representative embodiments, a restriction resource activation and/or deactivation may separate from the semi-persistent signal and/or channel resource and/or resource set activation and/or deactivation. In other words, a resource may be activated from a restriction resource point of view but deactivated from a signal and/or channel point of view, or vice versa. As an example, the resource corresponding to a semi-persistent PUSCH may be deactivated from the PUSCH point of view (e.g., the WTRU 102 may not transmit a PUSCH on the resource), but the corresponding restriction resource may be activated (e.g., it may impose restrictions on other WTRU 102 transmissions).

In certain representative embodiments, activation and/or deactivation of a restriction resource may be carried in the same or in a different MAC CE than the activation and/or deactivation of a signal and/or channel resource and/or resource set.

### Indication by DCI

In certain representative embodiments, a WTRU 102 may receive a DCI that carries an indication of one or more restriction resources. The DCI may indicate various resource allocation parameters of a restriction resource (e.g., a semi-persistent resource that is activated by a DCI). The DCI may indicate whether the resource is a restriction resource.

In certain representative embodiments, a DCI that schedules one or more transmissions and/or receptions may also indicate one or more restriction resources that may be applicable or may not be applicable to the scheduled transmissions and/or receptions.

In certain representative embodiments, a DCI may indicate whether or not the WTRU 102 should take any restriction resources into account when transmitting and/or receiving the scheduled transmissions and/or receptions, or if any applicable restriction resource(s) should be disregarded.

### Restriction Resource Priority

In certain representative embodiments, a WTRU 102 may receive an indication of a priority for a restriction resource. For example, candidate priority values may be ordered with a lowest and a highest priority (e.g., using integer numbers). For example, the lowest one or more priorities may correspond to no restriction, while the highest one or more priorities may correspond to restriction. In other words, a resource may be a restriction resource if the corresponding priority is among the priority values that correspond to restriction. Similarly, a resource may not be a restriction resource if the corresponding priority is among the priority values that correspond to no restriction. In an example, a priority value ‘0’ corresponds to no restriction and priority values ‘1’, ‘2’, and ‘3’ correspond to restriction, with ‘3’ corresponding to the highest priority valWTRU 102.

For example, the indication may be received in the configuration that configures the restriction resource. The indication may be received in a MAC CE or DCI that indicates a restriction resource (e.g., a restriction resource activation).

In some embodiments, the priority of a restriction resource may depend on the TCI state associated with the restriction resource. For example, a first restriction resource priority may correspond to a first TCI state associated with the restriction resource and a second restriction resource priority may correspond to a second TCI state associated with the restriction resource.

### Indication of Association Between Resource Groups and TCI States

### General

In certain representative embodiments, the network may transmit and the WTRU 102 may receive one or more configurations and/or reconfigurations to associate one or more of the (e.g., configured, indicated) resource groups to one or more (e.g., configured, indicated) TCI states.

In certain representative embodiments, an indication may associate one TCI state to one resource group.

In certain representative embodiments, an indication may associate one TCI state to multiple resource groups.

In certain representative embodiments, an indication may associate multiple TCI states to one resource group.

For example, a WTRU 102 may receive an indication to change the association between resource groups and TCI states (e.g., based on reconfiguration). The reassociation may follow the same approach as the initial association (e.g., always via RRC signaling or configuration), or it may be done differently, such as where the initial association may be provided over the configuration (e.g., RRC configuration) and re-association may be provided over MAC signaling (e.g., by a MAC CE).

In certain representative embodiments, a WTRU 102 may receive an indication of (e.g., all) the associated TCI states for a specific resource group in an association (re-)configuration (e.g., through RRC, MAC signaling, or via MAC CE). For example, any previously associated TCI state IDs for a specific resource group may be considered not associated for the specific resource group after receiving the reconfiguration by the WTRU 102. For example, the WTRU 102 may (e.g., alternatively) receive an indication in the reconfiguration whether the previously associated TCI state IDs are still valid for the specific resource group or not.

In certain representative embodiments, an indication may associate one or more (e.g., configured, indicated) resources or resource sets directly to one or more TCI states. For example, when certain configured resources or resource sets do not follow any other configured resources or resource sets, the network may not configure any resource group for this configured resource or resource set but associates it directly with one or more TCI states. For example, a CHOICE type ASN.1 encoding is defined where the TCI state is either associated with a resource group, a resource, or a resource set.

In certain representative embodiments, approaches described herein may be implemented both with and without the use of explicit resource groups in signaling, indications, configuration, etc. Resource groups may be a useful concept that may simplify explanation, description, and/or specification of WTRU 102 signaling, indication, and configuration. For example, a purpose of resource groups is to associate TCI states with resources and/or resource sets (e.g., one-to-one, one-to-multiple, and multiple-to-multiple associations).

### Indication by Configuration

In certain representative embodiments, a configuration or reconfiguration of the one or more resource groups and one or more TCI states may be received by the WTRU 102 (e.g., through RRC and/or MAC signaling). For example, the association (or at least initial association) between a resource group and a TCI state may be indicated within such configuration information.

In certain representative embodiments, an association between a TCI state and a resource group may be performed based on indication of a TCI state ID of the TCI state in the resource group configuration, or vice versa.

In certain representative embodiments, an association between a TCI state and a resource group may be done based on indications of both the TCI state ID and the resource group ID in a resource set configuration.

In certain representative embodiments, an association (e.g., by configuration or reconfiguration) may be provided in RRCSetup, RRCResume, RRCReconfiguration, RRCReestablishment, and/or any other RRC message.

In certain representative embodiments, upon (re-)configuration of an association by RRC signaling, the WTRU 102 may be able to apply the new association between a TCI state and a resource group (e.g., at the latest) upon transmission of a RRCSetup, RRCResume, RRCReconfiguration, RRCReestablishment complete message.

In certain representative embodiments, an association (e.g., configuration or reconfiguration) may be provided in MAC signaling message(s) which may be distinct from MAC CEs.

### Indication by MAC CE

In certain representative embodiments, a configuration or reconfiguration of the one or more resource groups and one or more TCI states may be received by a WTRU 102 (e.g., through RRC and/or MAC signaling).

In certain representative embodiments, an indication of association or re-association between the resource groups and the TCI states may be received by a WTRU 102 (e.g., via MAC CE(s)). For example, an initial association may be provided through the RRC and/or MAC signaling upon configuration of the TCI states and resource groups while a re-association may be provided by MAC CE(s). As another example, the associations may be (e.g., only) provided by MAC CE(s).

For example, a MAC CE for associating resource groups and TCI states may be received by the WTRU 102.

In certain representative embodiments, a MAC CE may provide the association of a resource group and one or more TCI states.

In certain representative embodiments, a MAC CE may provide the association of a TCI state and one or more resource groups.

In certain representative embodiments, a MAC CE may provide the association of one or more resource groups and one or more TCI states.

In certain representative embodiments, a MAC CE may provide the association of resource groups and resource sets.

In certain representative embodiments, a MAC CE that activates the one or more TCI states may also provide the association between a resource group ID and one or more resource set IDs (e.g., which are then associated with corresponding TCI state(s)).

In certain representative embodiments, a TCI state activation MAC CE may indicate (e.g., reconfigure) the association between TCI states and the resource groups while the association between a resource set and a resource group may (e.g., only) be provided by another means (e.g., via a different MAC CE and/or RRC/MAC signaling).

In certain representative embodiments, a TCI state activation MAC CE may comprise a set of TCI state IDs for the TCI states to be activated. In one example, for each of the TCI state IDs in the set of TCI state IDs, the MAC CE may indicate a resource group ID. In another example, for each of the TCI state IDs in the set of TCI state IDs, the MAC CE may indicate (e.g., by a bit) if a default resource group ID is to be associated with the TCI state for activation, or if the MAC CE also indicates a corresponding resource group ID. If so, the MAC CE may further comprise the corresponding resource group IDs.

In certain representative embodiments, a TCI state order (e.g., TCI state ID order) in the MAC CE may (e.g., implicitly) indicate an association with resource groups. For example, the MAC CE may map different sets of TCI states to different codepoints through the indication order in the MAC CE. The order may (e.g., also implicitly) associate sets of TCI states with resource groups. For example, the set of TCI states mapped to a first codepoint (e.g., ‘0’) by the MAC CE may be implicitly associated with a first resource group (e.g., with lowest resource group ID and/or ‘0’), the set of TCI states mapped to a second codepoint (e.g., ‘1’) by the MAC CE may be implicitly associated with a second resource group (e.g., with second lowest resource group ID and/or ‘1’), and so forth.

### Indication of Association Between Restriction Resources and TCI States

### General

In certain representative embodiments, the network may transmit and a WTRU 102 may receive one or more indications (e.g., configuration(s) and/or reconfiguration(s)) to associate one or more restriction resources with one or more TCI states.

In certain representative embodiments, a restriction resource may be associated with one or more TCI states. A TCI state may be associated with one or more restriction resources (e.g., the restriction resources in one or more restriction resource sets). For example, restriction resource and/or resource set may be associated with a TCI state set, and thereby associated with the TCI states in the TCI state set.

In certain representative embodiments, a restriction resource that is associated with a TCI state may imply that a WTRU 102 transmission and/or reception (e.g., of a signal and/or channel) on the restriction resource with the TCI state may be cancelled, omitted, or postponed.

### Indication by Configuration

In certain representative embodiments, a WTRU 102 may receive a configuration comprising an association between a restriction resource and/or restriction resource set and one or more TCI states and/or TCI state sets. For example, a restriction resource configuration and/or restriction resource set configuration may indicate one or more TCI states (e.g., by indicating one or more TCI state IDs or TCI state set IDs).

### Indication by MAC CE

In certain representative embodiments, a WTRU 102 may receive a MAC CE that carries an indication of associations between one or more restriction resources and/or restriction resource sets and one or more TCI states and/or TCI state sets.

For example, a MAC CE may indicate a bitmap. For example, a bitmap length may be equal to a number of configured restriction resources or restriction resource sets. A first bit (e.g., the least or most significant bit) may correspond to a first restriction resource (or restriction resource set), such as the resource with the lowest restriction resource ID (or restriction resource set ID). A set bit value (e.g., ‘1’) corresponding to a restriction resource (or resource set) may indicate that the MAC CE also comprises one or more indications of associated TCI state IDs and/or TCI state set IDs.

For example, a MAC CE may indicate one or more restriction resource IDs and/or restriction resource set IDs together with associated one or more TCI state IDs and/or TCI state set IDs.

In certain representative embodiments, a MAC CE that indicates any of the foregoing associations may (e.g., also) carry an indication of activation/deactivation of one or more restriction resources and/or restriction resource sets. For example, the MAC CE may indicate activation/deactivation (e.g., only) for the restriction resources and/or restriction resource sets for which one or more associated TCI states and/or TCI state sets are indicated. For example, the MAC CE may indicate the activation/deactivation of restriction resources and/or restriction resource sets, independently of which restriction resources and/or restriction resource sets the MAC CE has indicated associations.

In certain representative embodiments, a MAC CE that activates one or more TCI states may (e.g., also) indicate one or more associations between a TCI state activated by the MAC CE and one or more restriction resources and/or restriction resource sets. For example, the MAC CE may also activate the corresponding restriction resources. For example, the MAC CE may (e.g., implicitly) deactivate restriction resources not associated with the activated TCI states.

### Indication of TCI State Switching and Resource Activation/Deactivation

### General

In certain representative embodiments, the network may transmit and a WTRU 102 may receive an indication to switch from one or more first TCI states to one or more second TCI states. For example, the WTRU 102 may deactivate the one or more first TCI states and activate the one or more second TCI states. For example, TCI state switching may be performed between already activated TCI states.

In certain representative embodiments, TCI state activation/deactivation may be separate from TCI state switching (e.g., via separate MAC CEs).

In certain representative embodiments, TCI state switching may also correspond to a change of applicable resource group(s) and, hence, resource set(s). A resource group may be applicable (e.g., activated) if the resource group is associated with a TCI state that is applicable (e.g., activated).

In certain representative embodiments, upon TCI state switching, a WTRU 102 may activate the resource set(s) associated with an activated TCI state (e.g., by way of resource group to activated TCI state association, and/or resource group to resource set association).

In certain representative embodiments, upon TCI state switching, a WTRU 102 may deactivate the resource set(s) associated with a deactivated TCI state (e.g., by way of resource group to deactivated TCI state association, and/or resource group to resource set association).

In certain representative embodiments, multiple resource groups may be associated with an activated TCI state, and a WTRU 102 may receive an indication of which resource sets to apply (e.g., activate) by indicating one or more of the resource groups along with a TCI state activation (e.g., command), or the WTRU 102 may use a default one (e.g., in a case where there is no explicit network indication). For example, a default resource group may be indicated in a TCI state configuration.

In certain representative embodiments, a WTRU 102 may deactivate one or more resource sets (e.g., previously activated resource sets) which are not associated with the activated TCI state(s). For example, a WTRU 102 may receive an explicit activation of resource groups (e.g., and consequently the resource set(s)) in use. For example, the WTRU 102 may not activate resource groups and/or sets based on the TCI state switching but may only deactivate, while the WTRU 102 receives an explicit activation of the used resource groups and/or sets. This may also update the association between the TCI state(s) and the resource group(s) (e.g., the WTRU 102 implicitly associates the active TCI state(s) with the activated resource group(s)). In an example, the association may be based on the order of resource groups in an activation command. For instance, a first resource group (or corresponding ID) may be associated with a first TCI state (e.g., a TCI state associated with a first TCI codepoint), and so forth.

### Indication of TCI State Switching

In certain representative embodiments, a WTRU 102 may receive an indication to switch one or more TCI states. For example, a WTRU 102 may receive information indicating to switch to a first set of TCI states from a second set of TCI states. For example, the indication may indicate the first set of TCI states, as the second set may be already known due to previous indication(s). As examples, the indication may be carried in a MAC CE and/or a DCI.

In certain representative embodiments, a TCI state activation MAC CE may indicate TCI state switching. For example, if the MAC CE activates one or more TCI states for a single TCI codepoint. In this case, there may be no need to further indicate a codepoint in a subsequent DCI.

In certain representative embodiments, a DCI may carry an indication of TCI state switching (e.g., by indicating a TCI codepoint). For example, different TCI codepoints may be mapped to different sets of one or more TCI states.

In certain representative embodiments, a time delay after the reception of a TCI state switching indication, a (e.g., new) set of TCI states (e.g., the first set of TCI states) may become applicable, and the (e.g., old) previous set of TCI states (e.g., the second set of TCI states) may stop being applicable. For example, if a TCI state is in both the new and the old set of TCI states, it may remain applicable. In some embodiments, in which the successful reception of the channel carrying the indication (e.g., PDCCH or PDSCH) is associated with the transmission of a corresponding acknowledgement, the TCI state switching may occur a time offset after the transmission of the acknowledgement. In other embodiments, the TCI state switching may occur a time offset after the reception of the TCI state switching indication (e.g., a time offset after the reception of the corresponding PDCCH).

### Indication of Resource Set Among Associated Resource Sets and/or Indication of Resource in Associated Resource Set

In certain representative embodiments, a WTRU 102 may determine one or more applicable resource groups as the resource groups associated with one or more applicable TCI states (e.g., the first set of TCI states).

In certain representative embodiments, a WTRU 102 may receive an indication of one or more resource sets from the resource sets associated with a resource group (e.g., an applicable resource group). For example, a WTRU 102 may receive an indication of one or more resources from a resource set associated with the applicable resource group.

In certain representative embodiments, a resource group may be associated with multiple resource sets for one or more signal and/or channel types. For example, an indication may indicate a resource set per type. For instance, an indication may indicate a first resource set for a first type, a second resource set for a second type, and so forth. In one example, a resource set may be separately indicated for each associated type. In another example, there may be a common indication (e.g., the resource set with the lowest ID is indicated for each type, the resource set with the second lowest ID is indicated for each type, and so forth).

In certain representative embodiments, a resource set for a type may comprise multiple resources. An indication may indicate one or more resources from the multiple resources. In an example, an indication may indicate the resources from the resource sets for different types (e.g., separately). In another example, there may be a common indication (e.g., the resource with the lowest ID is indicated for each resource set, the resource with the second lowest ID is indicated for each resource set, and so forth).

In certain representative embodiments, an indication may comprise one or more resource allocation parameters for the corresponding resources and/or resource sets. For example, the allocation parameters may include a frequency domain resource allocation (e.g., any of an RB offset and/or a sub-carrier shift, a cyclic shift allocation, a code allocation, such as an orthogonal cover code (OCC) allocation) and/or a time domain resource allocation (e.g., a symbol allocation). In an example, one or more resource allocation parameters (e.g., for PDCCH resource allocation) may correspond to any of a set of resource element groups (REGs), a set of control channel elements (CCEs), a set of PDCCH candidates, and/or a set of aggregation levels.

In certain representative embodiments, the indication for resources and/or resource sets and/or resource allocation parameters as described herein may be received in a MAC CE. The MAC CE may associate the resource group with one or more TCI states, and/or a TCI state activation MAC CE. The applicable resource group may be a resource group associated with an activated TCI state. In one example, a resource group may be configured with a set of associated resource sets. For example, an (e.g., each) associated resource set may be configured with multiple sets of resources. By corresponding MAC CE signaling, an associated resource set from the set of associated resource sets may be indicated to the WTRU 102, or a set of resources from the multiple sets of resources in the associated resource set may be indicated.

In certain representative embodiments, an indication may be received in a DCI (e.g., that indicates TCI state switching). For example, the indication may apply to the one or more resource groups associated with one or more of the TCI states that the DCI indicates switching to (e.g., to the resource(s) and/or resource set(s) associated with the resource group(s)).

In certain representative embodiments, a resource and/or resource set indication may be beneficial in that more efficient resource utilization may be achieved in a multi-user scenario. When a resource associated with a TCI state is activated, it may be efficient that it is aligned with resources activated for other WTRU 102s for the same TCI state, such as in order to avoid fragmented resources.

### Resource Activation and Deactivation

In certain representative embodiments, upon switching to a TCI state or set, a WTRU 102 may activate associated resource set(s), and/or resource(s) in the associated resource set(s).

In certain representative embodiments, upon switching from a TCI state, a WTRU 102 may deactivate associated resource set(s), and/or resource(s) in the associated resource set(s). Similarly, the WTRU may activate and/or deactivate associated candidate (sub-)resource allocation(s).

In certain representative embodiments, one or more resource sets may be indicated (e.g., among the associated resource sets), and (e.g., only) the indicated resource sets may be activated. In certain representative embodiments, one or more resources may be indicated, and (e.g., only) the indicated resources may be activated.

For example, resource and/or resource set, activation and/or deactivation may occur at the same time as the corresponding TCI state switching. In some cases, a resource, or resource set, deactivation may occur upon the completion of a transmission or reception that is ongoing at the time of TCI state switching (e.g., transmission/reception of a resource to be deactivated).

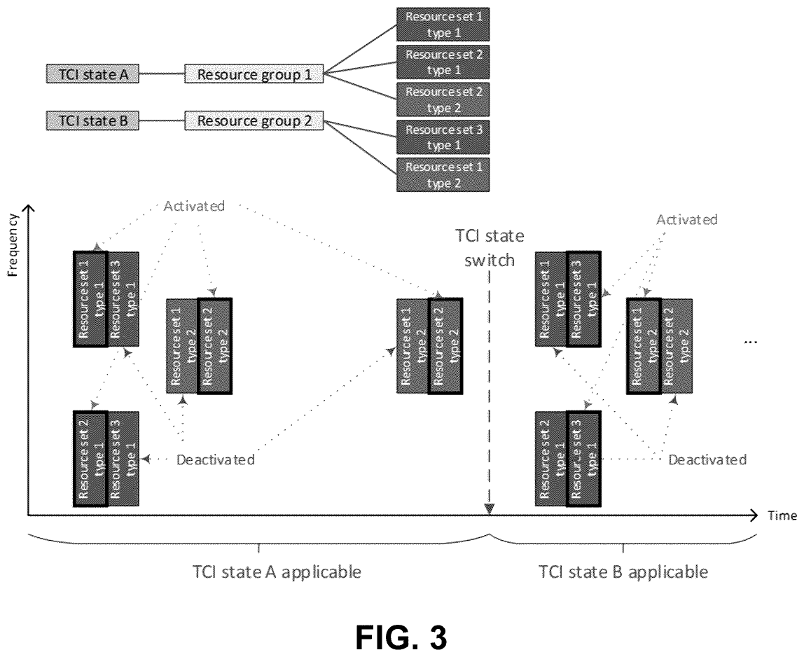

FIG. 3 is an association diagram illustrating an example of TCI state switching, according to one or more embodiments of the present disclosure. As shown in FIG. 3, TCI states A and B are associated with resource groups 1 and 2, respectively. A TCI state switch between TCI state A and TCI state B occurs at the indicated dashed arrow. Prior to the TCI state switch, TCI state A is applicable. Hence, the resource sets (or resources) associated with resource group 1 (and therefore TCI state A) are activated. In FIG. 3, the resource set 1 and the resource set 2 for a signal and/or channel type 1 and the resource set 2 for signal and/or channel type 2 are applicable for TCI state A. Since TCI state B is not applicable prior to the TCI state switch, the corresponding resource sets (or resources) are deactivated. In FIG. 3, the resource set 3 for signal and/or channel type 1 and the resource set 1 for signal and/or channel type 2 are applicable for TCI state B. Upon the TCI state switching from TCI state A to TCI state B, the resource sets (or resources) associated with TCI state A are deactivated and the resource sets (or resources) associated with TCI state B are activated.

In certain representative embodiments, there may be reasons for a resource being activated or deactivated other than TCI state switching. For example, a resource and/or resource set may be associated with (e.g., configured for) a BWP, serving cell, carrier, and/or similar. A resource may be deactivated if the associated BWP, cell, and/or carrier is deactivated. Similarly, a resource may be activated if the associated BWP, cell, and/or carrier is activated. Furthermore, a WTRU 102 may receive an explicit indication to activate or deactivate a resource or resource set, such as via an activation/deactivation MAC CE.

In certain representative embodiments, a first set of resources and/or resource sets may be indicated to be associated with a resource group (e.g., by configuration). Based on factors other than TCI state switching, such as deactivation or dormancy of an associated BWP(s), cell(s), and/or carrier(s), and/or explicit activation/deactivation, a first subset of the first set of resources and/or resource sets may be deactivated. A second subset may comprise the resources or resource sets in the first set of resources that are not in the first subset. In some cases, the second subset may comprise resources or resource sets from the first set that are associated with activated BWP(s), cell(s), and/or carriers(s), and/or that have been explicitly activated. For example, the activation/deactivation of resources and/or resource sets based on TCI state switching may be applied to the second subset of resources and/or resource sets. The second subset may be dynamically updated (e.g., based on WTRU 102 reception of indication(s) of activation/deactivation of BWP(s), cell(s), and/or carrier(s), and/or explicit activation/deactivation of resources and/or resource sets).

In certain representative embodiments, a WTRU 102 may receive an indication of activation or deactivation of a resource and/or resource set (e.g., in a MAC CE). The indication may be separate from the TCI state switching or TCI state activation. Hence, there may be multiple mechanisms by which a resource and/or resource set may be activated or deactivated.

In certain representative embodiments, multiple approaches to activation and deactivation may be used (e.g., in parallel). For example, a resource or resource set may be activated if the latest received indication across the multiple possible indications indicates activation. Similarly, a resource or resource set may be activated by a first mechanism (e.g., type of indication) and deactivated by a second mechanism (e.g., type of indication).

In certain representative embodiments, a resource and/or resource set that has been activated by an (e.g., explicit) indication to activate the resource or resource set may be deactivated by an (e.g., explicit) indication to deactivate and not by an indication to switch from a TCI state associated with the resource or resource set. Hence, the TCI state switching based resource or resource set activation/deactivation may operate on resources or resource sets that have been deactivated by the (e.g., explicit) activation/deactivation mechanism.

In certain representative embodiments, a resource and/or resource set that has been deactivated by an (e.g., explicit) indication to deactivate the resource or resource set may be activated by an (e.g., explicit) indication to activate, and not by an indication to switch to a TCI state associated with the resource or resource set. Hence, the TCI state switching based resource or resource set activation/deactivation may operate on resources or resource sets that have been activated by the (e.g., explicit) activation/deactivation mechanism.

### Indication to Transmit and/or Receive on a Set of Resources

### General

In certain representative embodiments, a WTRU 102 may receive an indication to transmit one or more signals and/or channels on a set of one or more resources. In certain representative embodiments, a WTRU 102 may receive an indication to receive one or more signals and/or channels on a set of one or more resources. As described herein, resources for transmission and/or reception may otherwise be referred to as resources for transmission/reception for brevity. As described herein, indicated resources may otherwise be referred to as indicated set of resources for clarity, such as to distinguish from resources for transmission/reception.

In certain representative embodiments, one or more resources in a set of resources may comprise sub-resources.

In certain representative embodiments, a WTRU 102 indication to transmit and/or receive on a set of resources may also comprise one or more TCI states applicable to the transmission and/or reception.

In certain representative embodiments, a WTRU 102 indication to transmit and/or receive on a set of resources may also comprise one or more priorities for the corresponding transmission and/or reception.

### Determination to Transmit and/or Receive Without Indication

In certain representative embodiments, a WTRU 102 may determine to transmit and/or receive one or more signals and/or channels on a set of one or more resources. The WTRU 102 may determine to transmit and/or receive based on an indication from higher layers. For example, the determination may be performed in a lower layer (e.g., layer 1) or in higher layers (e.g., layer 2 or layer 3). The determination may be based on there being UL data (e.g., available) to transmit. For example, the transmission of a scheduling request, buffer status report, or similar, may have been triggered. For example, the determination may be based on a measurement. For instance, the WTRU 102 may determine to transmit a measurement report based on a measurement result (e.g., if a measurement result, such as RSRP, is above a threshold). The measurement may correspond to a serving or a neighbor cell. For example, the determination may be based on the evaluation of one or more criteria by the WTRU 102 and determining that the applicable criteria are fulfilled. As an example, the one or more criteria may be based on a configuration received by the WTRU 102. For example, the one or more criteria may include (e.g., compare) one or more measurement results.

### Periodic Signals, Channels, and Resources

In certain representative embodiments, for a periodic signal, channel, and/or resource, an indication may be received in a configuration of the signal or channel, or the corresponding periodic resource.

In certain representative embodiments, the configuration may indicate to a WTRU 102 the set of resources to use for transmission and/or reception (e.g., a periodic resource).

In certain representative embodiments, the periodic signal, channel, and/or resource may be configured with one or more TCI states that are applicable to transmission and/or reception.

### Semi-Persistent Signals, Channels, and Resources

In certain representative embodiments, for a semi-persistent signal, channel, and/or resource, the indication may correspond to an activation of the signal or channel, or the corresponding semi-persistent resource. The indication may be carried in a configuration, a MAC CE, and/or a DCI. Similarly, the WTRU 102 may also receive an indication to deactivate the transmission and/or reception of the signal, channel, and/or resource.

In certain representative embodiments, the configuration of the semi-persistent signal, channel, and/or resource may indicate to the WTRU 102 the set of resources (e.g., a periodic or semi-persistent resource) to use for transmission and/or reception, when activated. One or more TCI states may also be configured.

In certain representative embodiments, a MAC CE or DCI that activates a semi-persistent signal and/or channel may also indicate a set of resources (e.g., at least partly). For example, a first part of a resource allocation may be indicated by configuration and a second part may be indicated by the activating MAC CE and/or DCI. The MAC CE and/or DCI may also indicate one or more TCI states applicable to the transmission and/or reception.

### Aperiodic Signals, Channels, and Resources

In certain representative embodiments, for an aperiodic signal, channel, and/or resource, the indication may correspond to a trigger to transmit or receive the signal or channel, or the corresponding aperiodic resource(s). The indication may be carried in a MAC CE and/or a DCI.

In certain representative embodiments, the MAC CE and/or DCI may also indicate the set of resources. In an example, the MAC CE and/or DCI may indicate one or more resource allocation parameters (e.g., explicitly). In other examples, the WTRU 102 may receive a configuration of one or more sets of resource allocations (e.g., time-domain resource allocations, frequency-domain resource allocations, etc.). The configuration may also indicate one or more TCI states. The MAC CE and/or DCI may indicate one or more resource allocations from the configured sets (e.g., a time-domain resource allocation and a frequency domain resource allocation). In an example with a transmission and/or reception indication via both MAC CE and an associated DCI, the MAC CE may indicate multiple resource allocations from the configured sets, and the DCI indicates one or more resource allocations from the resource allocations indicated by the associated MAC CE. The MAC CE and/or DCI may indicate one or more TCI states (e.g., from the configured, activated, and/or applicable one or more TCI states) to be applied to the transmission and/or reception.

In certain representative embodiments, a WTRU 102 may receive a configuration of one or more trigger states. The configuration of a trigger state may comprise a configuration of a resource, a configuration of one or more TCI states, etc. The WTRU 102 may receive a MAC CE that indicates a subset of the trigger states. The WTRU 102 may receive a DCI that indicates a trigger state from the subset of trigger states, or a trigger state from the configured trigger states. The received trigger state may trigger the reception and/or transmission according to the configuration of the trigger state. The resource allocation of the reception and/or transmission may be in relation to the resource of the received DCI (e.g., the first or last symbol or the slot of the channel, such as PDCCH, that carried the DCI).

### Determination of Set of Transmission and/or Reception Resources

### General

In certain representative embodiments, a WTRU 102 may determine a set of transmission and/or reception resources, or sub-resources (e.g., based on a set of indicated resources for transmission and/or reception, such as with corresponding signals and/or channels). For example, the determination may be based on the indicated priority corresponding to the transmission and/or reception. For example, the determination may be based on the indicated restriction resources. For example, the determination may be based on the activated restriction resources. For example, the determination may be based on the priorities of one or more restriction resources. For example, the determination may be based on the priorities of the one or more transmission and/or reception resources.

In certain representative embodiments, a WTRU 102 may (e.g., also) determine a set of transmissions and/or receptions on the determined set of transmission and/or reception resources, or sub-resources. For example, the determination may be based on the one or more TCI states to be applied to the set of transmission and/or reception resources or sub-resources.

### Determination of Collisions

In certain representative embodiments, a WTRU 102 may determine that there are one or more collisions for the set of indicated resources for transmission and/or reception. For example, the WTRU 102 may determine a collision if there is a resource, or sub-resource, overlap and whether a TCI state restriction is applicable for (e.g., due to) the resource overlap.

### Resource Overlap

In certain representative embodiments, a WTRU 102 may determine that there is a collision for an indicated resource, or a sub-resource of the indicated resource, if the resource overlaps, at least partly, with a restriction resource (e.g., an activated restriction resource). For example, the overlap may correspond to one or more of the dimensions that the resource corresponds to. For example, a WTRU 102 may determine that an indicated resource overlaps with a restriction resource if the resources (e.g., partially) overlap in time and/or frequency.

In certain representative embodiments, a resource may use (e.g., be configured with) frequency hopping, such as where a hop corresponds to a sub-resource. In certain representative embodiments, a resource may use (e.g., be configured with) time-domain repetition, such as where a repetition occasion corresponds to a sub-resource. In certain representative embodiments, a resource may use (e.g., be configured with) frequency-domain repetition, such as where a repetition occasion corresponds to a sub-resource. For example, the WTRU 102 may determine that one or more sub-resources overlap, at least partly, with one or more restriction resources (e.g., in time and/or frequency).

### TCI State Restriction

In certain representative embodiments, a WTRU 102 may determine that a TCI state restriction is applicable for an overlapping resource, or sub-resource. For example, the WTRU 102 may determine a TCI state restriction is applicable if the transmission and/or reception on the overlapping resource, or overlapping sub-resource, is associated with at least one TCI state that is associated with the restriction resource. The TCI state restriction may be applicable if the at least one TCI state is applicable to the transmission and/or reception on the part of the resource, or sub-resource, that overlaps (e.g., if the overlap is partial).

In certain representative embodiments, a WTRU 102 may determine that a collision occurs for an overlapping resource, overlapping sub-resource, and/or the corresponding transmission(s) and/or reception(s), if a TCI state restriction is applicable.

In certain representative embodiments, a WTRU 102 may determine that a partial TCI state restriction is applicable for an overlapping resource, or sub-resource, such as where the transmission and/or reception on the overlapping resource, or overlapping sub-resource, is associated with at least one TCI state that is associated with a restriction resource and is associated with a least one TCI state that is not associated with the restriction resource.

In certain representative embodiments, a WTRU 102 may determine that a partial collision occurs for the overlapping resource, overlapping sub-resource and/or the corresponding transmission(s) and/or reception(s), if a partial TCI state restriction is applicable.

### Restriction Priority

In certain representative embodiments, a WTRU 102 may use a (e.g., additional) priority-based criterion for determining if a TCI state restriction is applicable. The WTRU 102 may determine that a TCI state restriction is applicable if the restriction priority of the restriction resource is higher than (or equal to) the restriction priority of the overlapping resource, or overlapping sub-resource, or the corresponding signal and/or channel. For example, a TCI state restriction may be applicable if both a (e.g., same) TCI state is associated with (e.g., both) the restriction resource and the overlapping resource, and the priority criterion is met.

### Cancellation

In certain representative embodiments, a WTRU 102 may determine to (e.g., at least partially) cancel a transmission and/or reception of (e.g., using) a resource, or a corresponding signal and/or channel, based on the determination of collision for the resource. For example, the WTRU 102 may cancel the transmission and/or reception if the WTRU 102 determined that there is a collision for the resource. The WTRU 102 may cancel the transmission and/or reception of the whole resource or parts of the resource (e.g., the parts of the resource that overlap). Cancellation may imply that the transmission is not transmitted or that a reception is not received (e.g., monitored for and/or decoded). The cancellation of a reception (e.g., a reception of a PDSCH transmission) may also imply that a corresponding HARQ ACK/NACK is not transmitted by the WTRU 102, or that a corresponding ACK/NACK indication is not included in an ACK/NACK report. For example, a WTRU 102 may report ACK/NACK if at least one sub-resource is received (e.g., at least one PDSCH repetition). For example, the WTRU 102 may cancel and/or omit the ACK/NACK if all sub-resources are cancelled. In another example, the WTRU 102 may report a NACK if all resources or sub-resources are cancelled.

In certain representative embodiments, a WTRU 102 may determine to cancel the transmission of a sub-resource based on the determination of a collision for the sub-resource. In certain representative embodiments, a WTRU 102 may cancel the transmission if the WTRU 102 determines that there is a collision for the resource. In certain representative embodiments, a WTRU 102 may cancel the transmission of the whole resource or parts of the resource (e.g., the parts of the resource that overlap).

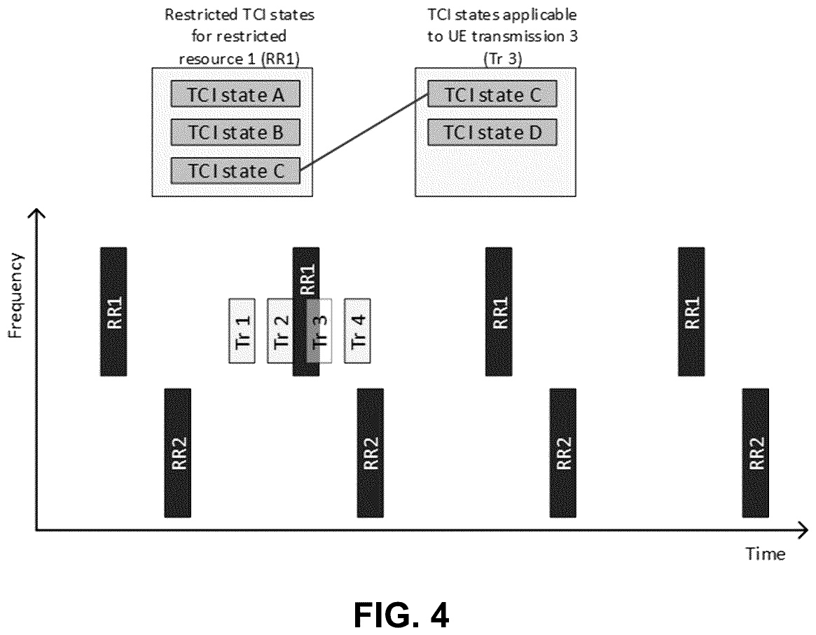

FIG. 4 is a resource diagram illustrating an example of cancellation of a WTRU transmission, according to one or more embodiments of the present disclosure. The WTRU 102 may be configured with a set of restriction resources RR1 and RR2. In the example shown in FIG. 4, the restriction resources RR1 and RR2 are periodic resources. The WTRU 102 may be indicated (e.g., scheduled) to perform a set of transmissions. In the example shown in FIG. 4, the WTRU 102 may be indicated to send four transmissions Tr1, Tr2, Tr3, and Tr4. For example, the four indicated transmissions may correspond to four indicated resources, or a resource with four sub-resources (e.g., a resource with four times repetition). In other examples, the WTRU 102 may use a transmission resource with frequency hopping. The four indicated transmissions may be associated with the same or different TCI states. Each restriction resource may be associated with a set of TCI states. In FIG. 4, the restriction resource RR1 is associated with TCI states A, B, and C, and Tr3 is associated with TCI states C and D.

In FIG. 4, the WTRU 102 determines that Tr3 overlaps with the restriction resource RR1. The WTRU 102 also determines that TCI state C is applicable to Tr3 and TCI state C is (e.g., also) associated with RR1. Therefore, the WTRU 102 determines that Tr3 collides with RR1 (e.g., an occasion of RR1). For example, the WTRU 102 may cancel the transmission of Tr3 and (e.g., only) send the transmissions Tr1, Tr2, and Tr4 (e.g., which do not collide).

In certain representative embodiments, multiple TCI states may be applicable for the transmission and/or reception of a resource (e.g., when multiple TCI states have been mapped to a TCI codepoint) that has been indicated as applicable. As shown in FIG. 4, for example, a WTRU 102 may determine a partial collision. For example, the WTRU 102 may determine a collision for a first TCI state applicable to a transmission and/or reception of a resource and may not determine a collision for a second TCI state applicable to the transmission and/or reception of the (e.g., same) resource (or sub-resource). The WTRU 102 may determine a partial cancellation of the transmission and/or reception. The transmission and/or reception corresponding to the first TCI state may be cancelled, while the transmission and/or reception corresponding to the second TCI state may not be cancelled.

In certain representative embodiments, such as cases of partial overlap, a WTRU 102 may determine to keep (e.g., not cancel) the non-overlapping part of the transmission and/or reception, or may cancel the whole transmission and/or reception (e.g., including the non-overlapping part). The determination may be based on a size of the non-overlapping part (e.g., in relation to the whole transmission and/or reception). For example, the WTRU 102 may determine to keep the (e.g., non-overlapping) part if its fraction of the whole is above a threshold. For example, the WTRU 102 may determine to keep the (e.g., non-overlapping) part if its size is above a threshold. For example, the WTRU 102 may determine to keep the (e.g., non-overlapping) part if the number of symbols of the part is above a threshold.

In certain representative embodiments, the determination may be based on if some particular part(s) of the transmission and/or reception are overlapping. For example, if one or more DMRSs are in the overlapping part, the WTRU 102 may determine to (e.g., also) cancel the non-overlapping part. For example, if the DMRS is in the overlapping part, the WTRU 102 may move the DMRS to the non-overlapping part and keep the non-overlapping part.

### Postponing

In certain representative embodiments, a WTRU 102 may determine to postpone the transmission and/or reception of (e.g., using) a resource and/or the corresponding signal and/or channel based on the determination of a collision for the resource. For example, the WTRU 102 may postpone the transmission and/or reception if the WTRU 102 determined that there is a collision for the resource. The WTRU 102 may postpone the transmission and/or reception of the whole resource or parts of the resource (e.g., the parts of the resource that overlap).

In certain representative embodiments, a postponed transmission and/or reception may be delayed to the first (e.g., next) eligible transmission and/or reception opportunity. An eligible transmission and/or reception opportunity may correspond to a resource allocation that fits the resource and/or that does not violate a rule. For example, a rule may correspond to WTRU 102 transmission in a time-frequency resource assigned to the DL, WTRU 102 reception in a time-frequency resource assigned to the UL, a number of different (e.g., simultaneous) WTRU 102 transmissions is above a threshold, a number of different (e.g., simultaneous) UL receptions is above a threshold, constraints on the number of simultaneously transmitted and/or received TCI states (e.g., transmissions and/or receptions using TCI states).

In certain representative embodiments, there may be repetition of sub-resources. For example, the postponing of a sub-resource may correspond to (e.g., include) the addition of a new sub-resource, such as at the end of the repetitions and/or according to a repetition rule (e.g., which may correspond to the time offset between subsequent repetitions, etc.). In some cases, the sub-resource order may be maintained, so that the last sub-resource, with corresponding TCI state(s), transmit power settings, redundancy version, cyclic shift(s), and/or scrambling ID, etc., whichever applicable depending on the resource type, is moved to the new sub-resource. In cases of multiple colliding sub-resources, multiple new sub-resources may be added (e.g., at the end), such as until all repetitions can be transmitted and/or received.

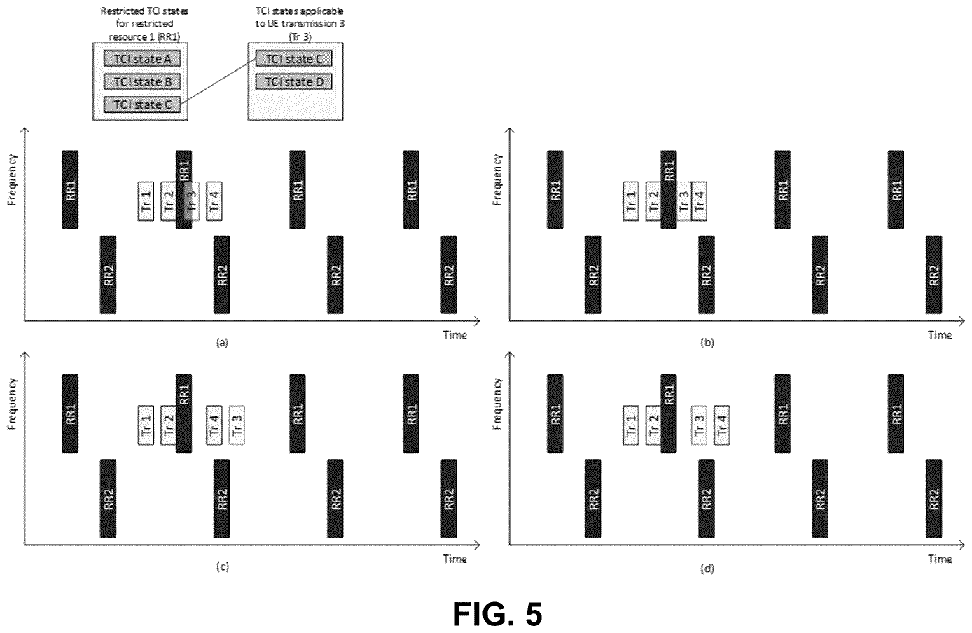

FIG. 5 is a comparative diagram illustrating examples of collision handling of a WTRU transmission, according to one or more embodiments of the present disclosure. In FIG. 5, example (a) reproduces the resource diagram of FIG. 4. In example, (a), the WTRU 102 determines that Tr3 collides with RR1. In example (b), the WTRU 102 may postpone Tr3 to the first (e.g., next) eligible transmission opportunity. In example, (b), the eligible transmission opportunity is shown to be right after RR1, but before Tr4. In another example, the first eligible transmission opportunity may occur after Tr4. In example (c), the WTRU 102 may add a new sub-resource after the end of the (e.g., non-colliding) repetitions. For example, when the colliding sub-resource is moved to a new sub-resource, any of the TCI state(s), redundancy version, cyclic shift(s), and/or scrambling, etc., if applicable, may be applied to the new sub-resource. In example (d), the WTRU 102 may add a (e.g., new) sub-resource at the end of the (e.g., non-colliding) repetitions. In example (d), the transmission order of the original transmissions is maintained. In another example, the example (c) may ne mixed with the example (d), for instance by moving some aspects of Tr3 to the new sub-resource (e.g., TCI state(s), transmit power setting, cyclic shift(s), and/or scrambling ID, whichever applicable depending on the resource type) while moving other aspects of Tr4 to the new sub-resource (e.g., redundancy version, if applicable).

### Re-ordering

In certain representative embodiments, a WTRU 102 may determine to re-order the transmission and/or reception of a set of indicated resources, or a set of indicated sub-resources, (e.g., with corresponding signal(s)/channel(s)) based on the determination of a collision for the set of indicated resources, or sub-resources. For simplicity, examples of re-ordering of sub-resources are described here, but the same or similar methods may be applied to the re-ordering of resources.

For example, re-ordering may be used to determine an order to the transmissions and/or receptions that avoids restriction (e.g., if different sub-resources are associated with different TCI state(s)).

In certain representative embodiments, re-ordering may be applied to the sub-resources that have been determined to collide. Other sub-resources may be kept as indicated.

In certain representative embodiments, re-ordering may be applied to sub-resources other than those determined to collide. For example, re-ordering may apply to all indicated sub-resources. The sub-resources to which the re-ordering applies may be called re-ordering sub-resources. The re-ordering sub-resources may be ordered according to their corresponding resource (e.g., in order of time, frequency, etc.). A re-ordering may correspond to changing the order (e.g., time-and/or frequency order) of transmission and/or reception of sub-resources (e.g., without adding new sub-resources). For example, the transmission and/or reception order may correspond to an order with which one or more parameters associated with the sub-resources are applied. For example, the parameters may comprise any of TCI state(s), transmit power setting, redundancy version, cyclic shift(s), and/or scrambling IDs, such as whichever may be applicable depending on the resource type or the like.

In certain representative embodiments, a WTRU 102 may determine a number of re-ordering sub-resources (e.g., to be used for re-ordering). For example, there may be an ordered set of permutations, such as where a permutation may correspond to a (e.g., specific) re-ordering of the sub-resources. The ordered set of permutations may, for example, be defined in a specification and/or configured to the WTRU 102. Knowledge of the ordered set of permutations may therefore be available at both the network and the WTRU 102. The WTRU 102 may determine a first permutation (e.g., with a lowest permutation ID) from the ordered set, such that a corresponding re-ordering (e.g., according to the first permutation) avoids collision. If no such permutation exists in the ordered set, the WTRU 102 may remove one or more sub-resource(s) from the re-ordering sub-resources and (e.g., again) try to determine a collision-free re-ordering (e.g., as above) based on the reduced set of re-ordering sub-resources. For example, the WTRU 102 may remove the first or last sub-resource, according to the order of the re-ordering sub-resources. A removed sub-resource may be cancelled or postponed, such as described herein.

In certain representative embodiments, a WTRU 102 may (e.g., try to) determine a collision-free re-ordering by initially removing a first re-ordering sub-resource. If none was found, the WTRU 102 may add back the first sub-resource, remove a second sub-resource from the re-ordered sub-resources which are then used to (e.g., try to) determine a collision-free re-order, and so forth.

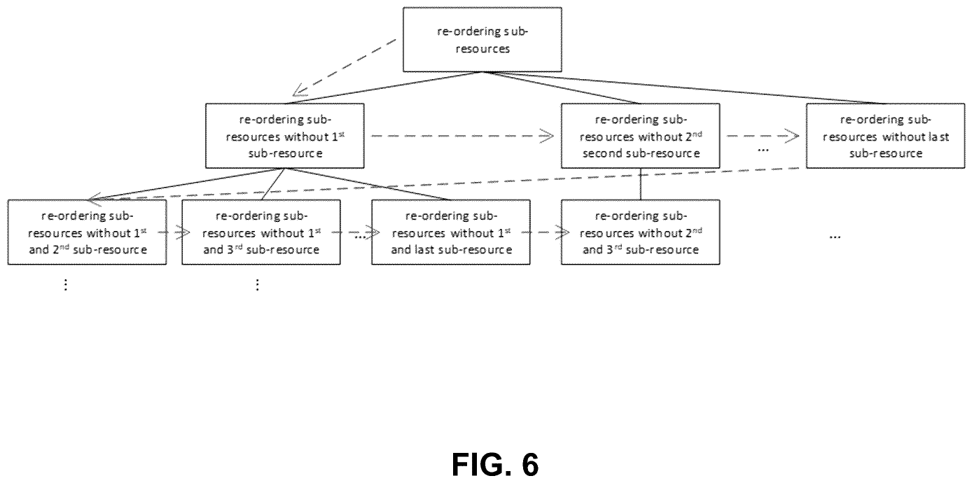

FIG. 6 is a re-ordering diagram illustrating an example of determining a re-ordering of sub-resources, according to one or more embodiments of the present disclosure. In FIG. 6, the top box represents the determined re-ordering sub-resources. Based on the re-ordering sub-resources for the re-ordering sub-resources, the WTRU 102 may determine a collision-free re-ordering or that no collision-free re-ordering exists. If so, the WTRU 102 may proceed to along the dashed line to determine a collision-free re-ordering based on a reduced set of re-ordering sub-resources. In FIG. 6, the dashed lines indicate a sequence of reduced sets of re-ordering sub-resources which the WTRU 102 may use to determine the collision-free re-ordering.

In certain representative embodiments, a set of permutations comprises cyclic shifts of resources (e.g., shifting resources in a direction, such as later or earlier in time) and/or moving a last resource to be first or moving a first resource to be last. For example, the order of the permutations may correspond to the number of cyclic shifts from the original order.

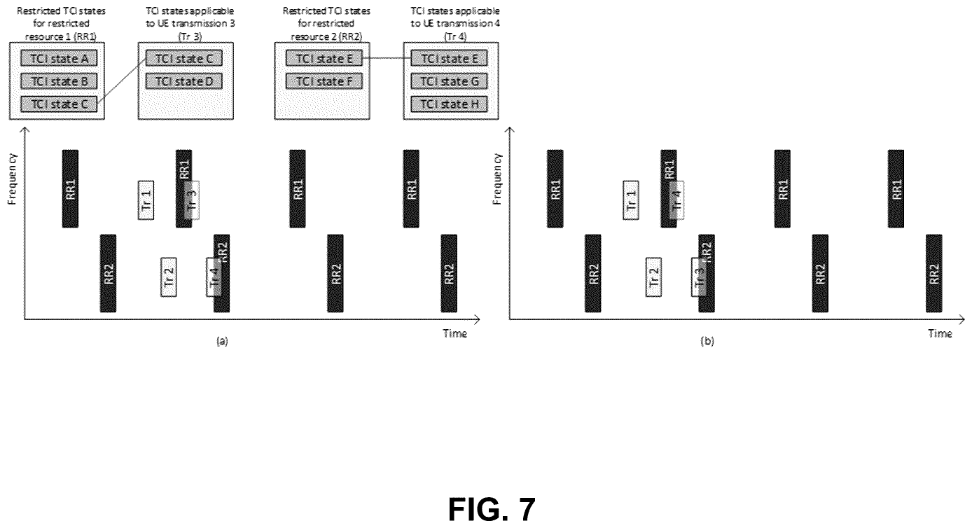

FIG. 7 is a comparative diagram illustrating examples of re-ordering of a WTRU transmission, according to one or more embodiments of the present disclosure. Similar to previous examples, the WTRU 102 may determine that a collision exists between transmission Tr3 and the restriction resource RR1. In addition, the WTRU 102 may determine that a collision (e.g., also) exists between transmission Tr4 and the restriction resource RR2 since the resources overlap and a TCI state E associated with the transmission Tr4 is among the restricted TCI states for the restriction resource RR2. For example, the WTRU 102 may determine the sub-resources corresponding to transmissions Tr3 and Tr4 as the re-ordering sub-resources. For the two re-ordering sub-resources, there may be a single permutation (e.g., re-ordering) other than the original order, which is the order swapping. Hence, the order swapping corresponds to the permutation in the ordered set of permutations. In FIG. 6, the WTRU 102 determines that the permutation (e.g., swapping transmissions Tr3 and Tr4) corresponds to a collision-free re-ordering (e.g., as transmission Tr3 and restriction resource RR2 do not have any TCI states in common, and transmission Tr4 and restriction resource RR1 do not have any TCI states in common). For example, the WTRU 102 may swap the time-frequency resources used for Tr4 and Tr3, resulting in that TCI states E, G, and H for sending the transmission Tr4 may be used on RR1 without restriction (e.g., and therefore without collision), and TCI states C and D for sending the transmission Tr3 may be used on RR2 without restriction (e.g., and therefore without collision).

### Indication and Selection of Cancellation, Postponing, or Re-ordering

In certain representative embodiments, a WTRU 102 may receive a selection indication to perform cancellation, postponing, and/or re-ordering. For example, a selection indication may (e.g., indicate to) select between cancellation and postponing, cancellation and re-ordering, postponing and re-ordering, or between all three, in various examples.

For example, a selection indication may be carried together with an indication to transmit and/or receive on a set of resources, such as in any of a configuration, a MAC CE and/or DCI activation, and/or DCI scheduling and the like. The selection indication may indicate to the WTRU 102 to apply the indicated method to any collision(s) for the indicated transmissions and/or receptions on the set of resources.

For example, a selection indication may be carried together with an indication of one or more restriction resources, such as in any of a configuration, an activation MAC CE, and/or an indication of an association between any restriction resources and TCI states. The selection indication may apply to the indicated restriction resources. For example, in a case of a collision with a restriction resource, the WTRU 102 may apply a method (e.g., of resolving the collision) based on the selection indication received with the indication of the colliding restriction resource.

### Transmission and Reception

### General

In certain representative embodiments, a WTRU 102 may transmit and/or receive one or more signals and/or one or more channels on the corresponding indicated resources, or a subset thereof.

For example, the WTRU 102 may perform the determined transmission(s) and/or reception(s) on a determined set of transmission and/or reception resources, or sub-resources, such as upon the determination of any collisions. Each of the determined transmissions and/or receptions may be associated with any of TCI state(s), redundancy version(s), transmit power setting, cyclic shift(s), and/or scrambling ID(s) (e.g., which may be separately applicable depending on the corresponding resource type).

In certain representative embodiments, a WTRU 102 may have determined to cancel one or more resources, or one or more sub-resources, from a set of indicated resources, and the WTRU 102 may transmit and/or receive (e.g., using) the remaining resource(s), or sub-resource(s), that were not cancelled. For example, where all (e.g., indicated) resources were cancelled, such as if a single resource was indicated and cancelled, the WTRU 102 may skip the corresponding transmission and/or reception.

In certain representative embodiments, a WTRU 102 may transmit or receive (e.g., using) activated resources (e.g., resources belonging to an activated resource set, using the associated TCI state(s)). For example, the WRTU may transmit or receive on (e.g., any) activated candidate (sub-)resource allocations.

In certain representative embodiments, a WTRU 102 may receive a PDCCH transmission, and the WTRU 102 may subsequently perform the steps (e.g., transmission and/or reception) indicated by the PDCCH (e.g., by the indications in a DCI carried by the PDCCH).

In certain representative embodiments, a WTRU 102 may receive a PDSCH transmission, and the WTRU 102 may subsequently report HARQ ACK/NACK information corresponding to the received PDSCH transmission.

In certain representative embodiments, a WTRU 102 may receive a CSI-RS, and the WTRU 102 may perform one or more associated actions. For example, the WTRU 102 may perform a measurement on the received CSI-RS and report associated measurement result information to the network in a CSI report. In another example, in which the received CSI-RS may be a QCL source RS, the WTRU 102 may perform measurements and parameter estimation based on the received CSI-RS in order to improve the reception performance of a subsequent QCL target signal and/or channel (e.g., a PDSCH, or its DMRS). In certain representative embodiments, the measurements and parameter estimation may correspond to synchronization (e.g., fine time-frequency synchronization), Rx beam adjustment, and the like.

In certain representative embodiments, a WTRU 102 may perform link monitoring (e.g., radio link monitoring or beam failure detection) based on periodic measurements on DL RS(s) (e.g., CSI-RS). For example, the WTRU 102 may use one or more DL RS occasions to evaluate link monitoring (e.g., to determine if the link has failed or not). If the WTRU 102 does not receive a DL RS in a DL RS occasion as described herein (e.g., due to cancellation due to collision), the WTRU 102 may omit the occasion from link monitoring evaluation. For instance, if the WTRU 102 counts occasions with link quality below a threshold, the WTRU 102 may omit the (e.g., not received) DL RS occasions from the counting.

### CSI Measurement and Reporting

In certain representative embodiments, a CSI reporting configuration may be associated with multiple resource sets of a type (e.g., CSI-RS) for CSI measurement. In certain representative embodiments, a subset of the resource sets (e.g., a single set) may be activated, such as depending on the applicable TCI state(s).

In certain representative embodiments, multiple resource sets for CSI measurement may be activated (e.g., if multiple resource sets were associated to the same resource group or if multiple resource groups are simultaneously applicable, such as where multiple TCI states are applicable at the same time). For example, the WTRU 102 may determine one of the activated resource sets for CSI measurement (e.g., based on a rule), such as a resource set associated with a particular TCI state (e.g., a first TCI state among multiple applicable TCI states, such as where multiple TCI states may be associated with the same TCI codepoint). The WTRU 102 may have been indicated (e.g., by configuration) as to which of the TCI states among the multiple TCI states to use for determining a resource set for CSI measurement. In other cases, the WTRU 102 may perform CSI measurement on multiple activated resource sets.

In certain representative embodiments, a WTRU 102 may perform CSI measurement on one or more of the activated resource sets.

In certain representative embodiments, a CSI reporting configuration may be associated with multiple resource sets of a type (e.g., PUCCH and/or PUSCH) for CSI reporting. A subset of the resource sets (e.g., a single set) may be activated, such as depending on the applicable TCI state(s). For example, the WTRU 102 may determine a resource (or resource set) among the activated resources (or resource sets) of the corresponding type for the transmission of one or more CSI report(s).

In certain representative embodiments, a WTRU 102 may transmit one or more CSI reports on the determined resources or resource sets

### Example Procedures

In certain representative embodiments, in order to have a WTRU 102 use appropriate resources corresponding to one or more types of signals and/or channels for an applied TCI state (e.g., the applied beam), TCI states may be associated, such as by using a resource group. As an example, a resource group may in turn be associated with one or more resource sets, such where a resource set may correspond to a particular signal and/or channel type. Upon TCI state switching, the WTRU 102 may activate resource sets associated with the new applicable TCI state and/or deactivate any other activated resource sets.

For example, periodic transmission with adaptive resource allocation may be achieved by activating and/or deactivating semi-persistent resources upon TCI state switching.

In certain representative embodiments, a WTRU 102 may be configured with a set of TCI states.

In certain representative embodiments, a WTRU 102 may be configured with a set of resource groups.

In certain representative embodiments, a WTRU 102 may be configured with a set of signal and/or channel types. As an example, the signal and channel types may include, among others, PUCCH and SRS. For each of the signal and/or channel types in the set, the WTRU 102 may be configured with a corresponding set of resource sets, where the resources thereof may be semi-persistent.

In certain representative embodiments, a WTRU 102 may receive an indication of an association to a resource group. As an example, in the configuration of a resource set, the resource set may be configured with an association with a resource group (e.g., with a resource group index). As an example, the WTRU 102 may receive a MAC CE that indicates an association with a resource group and one or more resource sets.

In certain representative embodiments, a WTRU 102 may receive one or more indications that associate one or more TCI states with one or more resource groups (e.g., one-to-one association, multiple-to-one association, or one-to-multiple association). As an example, the indications may be configured in the resource group configurations. As an example, the WTRU 102 may receive a MAC CE that indicates the association(s) (e.g., a MAC CE that also activates the TCI states).

In certain representative embodiments, a WTRU 102 may receive an indication to switch from a first TCI state to a second TCI state.

In certain representative embodiments, upon (e.g., after) TCI state switching, a WTRU 102 may WTRU 102 activate the resource set(s) that are associated with the second TCI state, and may deactivate the resource set(s) that are associated with the first TCI state.

In certain representative embodiments, a WTRU 102 may transmit and/or receive one or more transmissions with the activated resource set(s) using the second TCI state.

In certain representative embodiments, a WTRU 102 may receive an indication to switch from a first TCI state to a second TCI state, whereby the WTRU 102 deactivates a first set of resources associated with the first TCI state and activates a second set of resources associated with the second TCI state.

In certain representative embodiments, a WTRU 102 may efficiently adapt the resource allocation of periodic or semi-persistent signals and/or channels upon TCI state switching. This can assist with network implementations since a TRP may keep serving multiple WTRUs in the same resource (e.g., symbol) using the same TRP beam.

In certain representative embodiments, the network may have and/or place restrictions on the TCI states that can be used in a time-frequency resource (e.g., a restriction resource). For example, a TRP may not be able to receive a certain beam in a set of RBs in a symbol (e.g., since it receives other beam(s) in these resources). For example, it may be beneficial to avoid unnecessary WTRU 102 transmission and/or reception on a restriction resource using a restricted TCI state, (e.g., a TCI state that is not to be used on the restriction resource).

As shown in FIG. 4, as an example, a WTRU 102 may be configured and/or indicated with a set of restriction resources, such as the two restriction resources RR1 and RR2, and multiple WTRU transmissions, such as transmissions Tr1 to Tr4. As an example, the transmissions Tr1 to Tr4 may represent an UL transmission with 4 times repetition. The RR1 has an associated set of restricted TCI states comprising TCI states A, B, and C. The WTRU 102 transmission Tr3 has two applicable TCI states, namely TCI state C and D. Since the TCI state C applicable to the transmission Tr3 is included in the set of restricted TCI states, the WTRU 102 may determine a collision and may proceed to cancel the transmission Tr3, such as while still sending the remainder of the UL transmission.

In certain representative embodiments, a WTRU 102 may be configured with a set of TCI states.

In certain representative embodiments, a WTRU 102 may be configured with a set of restriction resources. For example, a restriction resource may correspond to a (e.g., periodic) time-frequency resource.

In certain representative embodiments, a WTRU 102 may, for a restriction resource in the set, receive an indication of an associated set of restricted TCI states. For example, the indication may be received in the configuration of the restriction resource. For example, the indication may be received in a MAC CE (e.g., that also may activate the restriction resource).

In certain representative embodiments, a WTRU 102 may receive one or more indications to transmit and/or receive a set of signals and/or channels on a set of transmission and/or reception resources.

For example, the transmission and/or reception of different signals and/or channel may be associated with different TCI states.

For example, the transmission and/or reception a signal and/or channel may include repetition, such as where each repetition (e.g., using a sub-resource) may be associated with a set of TCI states.

For example, the transmission and/or reception a signal and/or channel may include frequency hopping, such as where each hop (e.g., using a sub-resource) may be associated with a set of TCI states.

In certain representative embodiments, a WTRU 102 may determine at least one transmission and/or reception resource that overlaps, at least partly, with a restriction resource. The WTRU 102 may determine that the overlapping transmission and/or reception resource is associated with at least one TCI state that is included in the set of restricted TCI states (e.g., associated with the restriction resource).

In certain representative embodiments, a WTRU 102 may, based on the determination, determine a subset of resources for transmission and/or reception, by excluding a subset of cancelled transmission and/or reception resources from the set of transmission/reception resources.

For example, if the overlap is partial, the WTRU 102 may cancel the whole transmission and/or reception resource or the part that overlaps.

For example, if the transmission and/or reception comprises repetition, the WTRU 102 may cancel the repetition(s) that overlap.

For example, if the transmission and/or reception comprises frequency hopping, the WTRU 102 may cancel the hop(s) that overlap.

For example, if the transmission and/or reception is associated with both restricted and non-restricted TCI states, the WTRU 102 may determine to cancel only the transmission and/or reception using (e.g., each of) the restricted TCI states and may determine to (e.g., still) transmit and/or receive using (e.g., each of) the non-restricted TCI states.

In certain representative embodiments, a WTRU 102 may transmit (e.g., using) the determined subset of resources for transmission and/or reception.

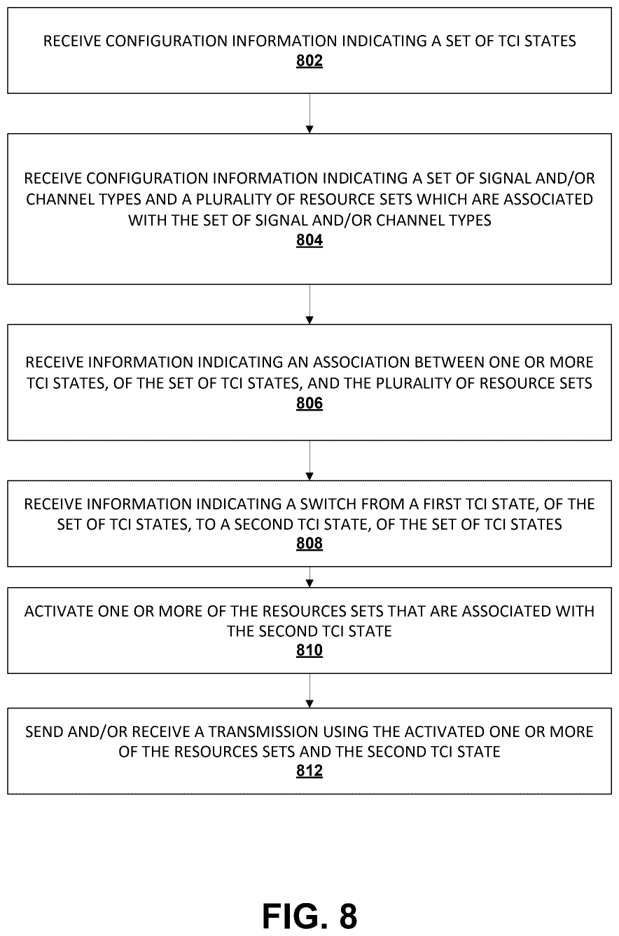

FIG. 8 is a procedural diagram illustrating an example of a beam-dependent use of transmission and/or reception resources, according to one or more embodiments of the present disclosure. As shown in FIG. 8, a WTRU 102 may receive configuration information indicating a set of TCI states at 802. At 804, the WTRU 102 may receive configuration information indicating a set of signal and/or channel types and a plurality of resource sets which are associated with the set of signal and/or channel types. At 806, the WTRU 102 may receive information indicating an association between one or more TCI states, of the set of TCI states, and the plurality of resource sets. At 808, the WTRU 102 may receive information indicating a switch from a first TCI state, of the set of TCI states, to a second TCI state, of the set of TCI states. At 810, the WTRU 102 may activate one or more of the resources sets that are associated with the second TCI state. At 812, the WTRU 102 may send and/or receive a transmission using the activated one or more of the resources sets and the second TCI state.

In certain representative embodiments, any (e.g., each) respective signal and/or channel type may be associated with one or more of the resource sets.

In certain representative embodiments, (e.g., any of) one or more of the resource sets may include semi-persistent and/or periodic resources.

In certain representative embodiments, the WTRU 102 may receive configuration information indicating a set of resource groups. The WTRU 102 may receive information indicating an association between the set of resource groups and the plurality of resource sets. The WTRU 102 may receive information indicating an association between the one or more TCI states and one or more resource groups of the set of resource groups.

In certain representative embodiments, the information indicating the association between the one or more TCI states and one or more resource groups may be included in (i) the configuration information indicating the set of resource groups or (ii) a MAC CE.

In certain representative embodiments, the information indicating the association between the set of resource groups and the plurality of resource sets may be included in (i) the configuration information indicating the plurality of resource sets or (ii) a MAC CE.

In certain representative embodiments, a respective TCI state of the set of TCI states may be associated with a respective resource group of the set of resource groups.

In certain representative embodiments, two or more TCI states of the set of TCI states may be associated with a respective resource group of the set of resource groups.

In certain representative embodiments, a respective TCI state of the set of TCI states may be associated with two or more resource groups of the set of resource groups.

In certain representative embodiments, the WTRU 102 may deactivate one or more of the resources sets associated with the resource groups that are associated with the first TCI state.

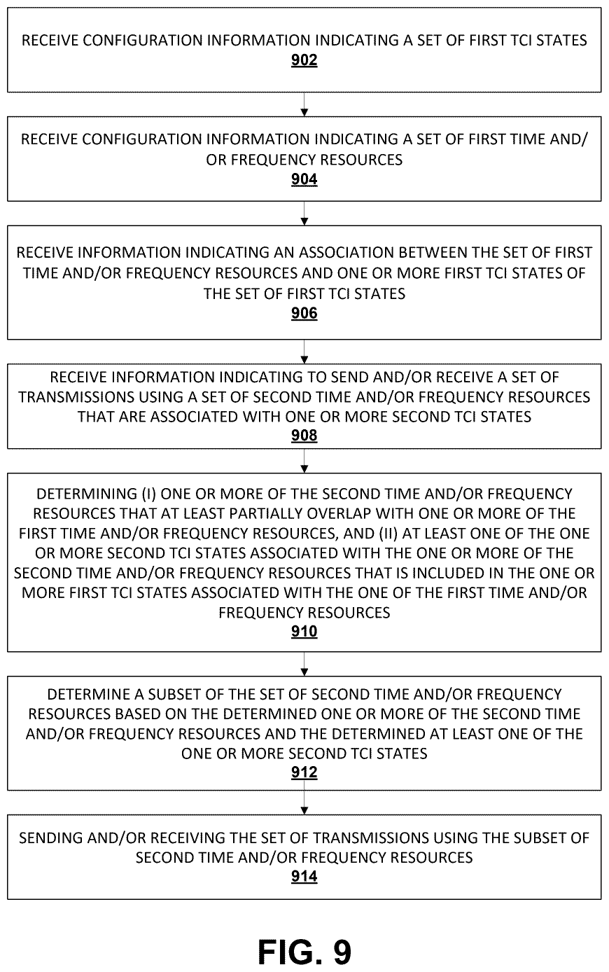

FIG. 9 is a procedural diagram illustrating an example of restriction resource-based use of transmission and/or reception resources, according to one or more embodiments of the present disclosure. As shown in FIG. 9, a WTRU 102 may receive configuration information indicating a set of first TCI states at 902. At 904, the WTRU 102 may receive configuration information indicating a set of first time and/or frequency resources. At 906, the WTRU 102 may receive information indicating an association between the set of first time and/or frequency resources and one or more first TCI states of the set of first TCI states. At 908, the WTRU 102 may receive information indicating to send and/or receive a set of transmissions using a set of second time and/or frequency resources that are associated with one or more second TCI states. At 910, the WTRU 102 may determine (i) one or more of the second time and/or frequency resources that at least partially overlap with one or more of the first time and/or frequency resources, and (ii) at least one of the one or more second TCI states associated with the one or more of the second time and/or frequency resources that is included in the one or more first TCI states associated with the one of the first time and/or frequency resources. At 912, the WTRU 102 may determine a subset of the set of second time and/or frequency resources based on the determined one or more of the second time and/or frequency resources and the determined at least one of the one or more second TCI states. At 914, the WTRU 102 may send and/or receive the set of transmissions using the subset of second time and/or frequency resources.

In certain representative embodiments, the set of first time and/or frequency resources may include periodic resources.

In certain representative embodiments, any (e.g., each) transmission of the set of transmissions may be associated with at least one of the second TCI states.

In certain representative embodiments, the set of transmissions may include one or more repetitions.

In certain representative embodiments, the set of transmissions may include transmissions of a first type and a second type. For example, the transmissions of the first type may be associated with a first subset of the second TCI states and the transmissions of the second type may be associated with a second subset of the second TCI states.

In certain representative embodiments, the subset of the set of second time and/or frequency resources may not include the one or more of the second time and/or frequency resources that at least partially overlap with the one or more of the first time and/or frequency resources.

In certain representative embodiments, the subset of the set of second time and/or frequency resources may include the second time and/or frequency resources other than the one or more of the second time and/or frequency resources that at least partially overlap with the one or more of the first time and/or frequency resources.

In certain representative embodiments, the set of transmissions may be sent and/or received using the subset of second time and/or frequency resources and any of the second TCI states (e.g., depending on how collisions are resolved by the WTRU 102).

In certain representative embodiments, the information indicating the association between the set of first time and/or frequency resources and the one or more first TCI states of the set of first TCI states may be included in (i) the configuration information indicating the set of first time and/or frequency resources or (ii) a MAC CE.

In certain representative embodiments, the set of first TCI states are restricted TCI states and/or the set of first time and/or frequency resources are restricted resources.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A method implemented by a wireless transmit/receive unit (WTRU), the method comprising:
receiving configuration information indicating a set of transmission configuration indication (TCI) states;
receiving configuration information indicating a set of signal and/or channel types and a plurality of resource sets which are associated with the set of signal and/or channel types;
receiving information indicating an association between one or more TCI states, of the set of TCI states, and the plurality of resource sets;
receiving information indicating a switch from a first TCI state, of the set of TCI states, to a second TCI state, of the set of TCI states;
activating one or more of the resources sets that are associated with the second TCI state; and
sending and/or receiving a transmission using the activated one or more of the resources sets and the second TCI state.

2. The method of claim 1, wherein each respective signal and/or channel type is associated with one or more of the resource sets.

3. The method of claim 1, wherein one or more of the resource sets include semi-persistent and/or periodic resources.

4. The method of claim 1, further comprising:
receiving configuration information indicating a set of resource groups;
receiving information indicating an association between the set of resource groups and the plurality of resource sets; and
receiving information indicating an association between the one or more TCI states and one or more resource groups of the set of resource groups.

5. The method of claim 4, wherein the information indicating the association between the one or more TCI states and one or more resource groups is included in (i) the configuration information indicating the set of resource groups or (ii) a medium access control (MAC) control element (CE).

6. The method of claim 4, wherein the information indicating the association between the set of resource groups and the plurality of resource sets is included in (i) the configuration information indicating the plurality of resource sets or (ii) a medium access control (MAC) control element (CE).

7. The method of claim 4, wherein a respective TCI state of the set of TCI states is associated with a respective resource group of the set of resource groups.

8. The method of claim 4, wherein two or more TCI states of the set of TCI states are associated with a respective resource group of the set of resource groups.

9. The method of claim 4, wherein a respective TCI state of the set of TCI states is associated with two or more resource groups of the set of resource groups.

10. The method of claim 1, further comprising:
deactivating one or more of the resources sets that are associated with the first TCI state.

11. A wireless transmit/receive unit (WTRU) comprising:
a processor, memory, and a transceiver which are configured to:
receive configuration information indicating a set of transmission configuration indication (TCI) states,
receive configuration information indicating a set of signal and/or channel types and a plurality of resource sets which are associated with the set of signal and/or channel types,
receive information indicating an association between one or more TCI states, of the set of TCI states, and the plurality of resource sets,
receive information indicating a switch from a first TCI state, of the set of TCI states, to a second TCI state, of the set of TCI states,
activate one or more of the resources sets that are associated with the second TCI state, and
send and/or receive a transmission using the activated one or more of the resources sets and the second TCI state.

12. The WTRU of claim 11, wherein each respective signal and/or channel type is associated with one or more of the resource sets.

13. The WTRU of claim 11, wherein one or more of the resource sets include semi-persistent and/or periodic resources.

14. The WTRU of claim 11, wherein the processor, the memory, and the transceiver are configured to:
receive configuration information indicating a set of resource groups,
receive information indicating an association between the set of resource groups and the plurality of resource sets, and
receive information indicating an association between the one or more TCI states and one or more resource groups of the set of resource groups.

15. The WTRU of claim 14, wherein the information indicating the association between the one or more TCI states and one or more resource groups is included in (i) the configuration information indicating the set of resource groups or (ii) a medium access control (MAC) control element (CE).

16. The WTRU of claim 14, wherein the information indicating the association between the set of resource groups and the plurality of resource sets is included in (i) the configuration information indicating the plurality of resource sets or (ii) a medium access control (MAC) control element (CE).

17. The WTRU of claim 14, wherein a respective TCI state of the set of TCI states is associated with a respective resource group of the set of resource groups.

18. The WTRU of claim 14, wherein two or more TCI states of the set of TCI states are associated with a respective resource group of the set of resource groups.

19. The WTRU of claim 14, wherein a respective TCI state of the set of TCI states is associated with two or more resource groups of the set of resource groups.

20. The WTRU of claim 11, wherein the processor, the memory, and the transceiver are configured to:
deactivate one or more of the resources sets that are associated with the first TCI state.
